(19) United States
(12) Patent Application Publication
(10) Pub. No.: US 2010/0081391 A1
(43) Pub. Date: Apr. 1, 2010

(54) WIRELESS COMMUNICATION SYSTEM

(75) Inventors: Yusuke Suzuki, Kawasaki (JP); Kazuhiko Yamaguchi, Kawasaki (JP); Junichi Takagi, Kawasaki (JP); Yoshiaki Kumagai, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/564,396

(22) Filed: Sep. 22, 2009

(30) Foreign Application Priority Data
Sep. 29, 2008 (JP) 2008-250366

(51) Int. Cl. H04B 17/00; H04B 1/00

(52) U.S. Cl. 455/67.11; 455/68

(57) ABSTRACT

A wireless communication system capable of using a plurality of frequency channels in a first predetermined frequency band being adjacent a second predetermined frequency band used in another wireless communication system, the wireless communication system includes a base station and a mobile station. The base station sends a notification for limiting each power of the plurality of frequency channels to the mobile station. The mobile station transmits data to the base station by the use of at least one of the frequency channel, and controlling data transmitting power based upon the notification. When the frequency channel for the data transmitting need more transmitting power and the frequency channel for the data transmitting is adjacent to the second predetermined frequency band, the mobile station change the frequency channel for the data transmitting.

### CROSS-REFERENCE TO RELATED APPLICATION

This application is based upon and claims the benefit of priority of the prior Japanese Patent Application No. 2008-250366, filed on Sep. 29, 2008, the entire contents of which are incorporated herein by reference.

### FIELD

The embodiments discussed herein are related to a wireless communication system.

### BACKGROUND

Since ultra high frequency (UHF) used in television broadcasting, wireless LAN, GPS, ETC, mobile phones, and the like is stable in radio waves and can be used to transmit/receive a large amount of information by using small-sized communication devices, it has been considered that the need for UHF will increase in the future particularly in mobile communication systems. As a latest communication system using UHF, research and development of ITS (Intelligent Transport Systems) which intends to solve road transportation problems such as traffic accidents and traffic jams by performing wireless communication among an infrastructure system, vehicles, and mobile phones is actively being conducted. For example, an electronic toll collection system (ETC) for preventing traffic jams at toll gates, a road traffic information providing service for performing route guidance to prevent traffic jams by linking GPS and car navigation systems, a bus location system in which the current bus location can be checked using a mobile phone, or a waiting time information system at bus stops, and the like have already been put to practical use.

Here, in the wireless communication field, a frequency band is allocated to a provider who provides a communication service, and each service provider constructs a wireless communication system using frequencies within an allocated frequency band. For example, in a mobile phone system in which communication is performed between a base station and mobile phones, a signal is transmitted to multiple addresses from the base station by using each of multiple frequency channels belonging to an allocated frequency band. In each mobile phone, a frequency channel of a received signal having the strongest radio wave of all the received signals is selected and wireless communication with the base station is performed using the selected frequency channel. There is a technique for preventing a load from concentrating on a particular frequency channel by varying the radio wave reachable area of each of the multiple frequency channels. There is also a technique for preventing communication from being cut off, and the like when the frequency channel is switched due to movement of the user, by overlapping areas which each radio wave of the multiple frequency channels can reach (for example, Patent Documents 1 and 2). By applying these techniques, highly reliable communication can be realized within an allocated frequency band.

However, it is difficult to concentrate signal electric power only at a predetermined frequency, and generally, electric power spreading components (sidelobes) are usually generated in nearby areas of the predetermined frequency. Therefore, there is a risk that a signal used for communication in a system may leak into a frequency band of another system, and interfere with a signal used for communication in the other system. As methods for solving the problem, a method in which a wide width of frequency band (guard band) between frequency bands allocated to providers is secured, a method in which a filter for removing the sidelobes is mounted in an apparatus, and a method which uses a directionality controllable adaptive antenna to transmit a signal only to a target apparatus are considered.

Japanese Laid-open Patent Publication No. 2005-347976 and Japanese Laid-open Patent Publication No. 2000-125333 are related art.

However, in recent years, frequency resources are becoming scarce. Therefore, there is a problem that the method which secures wide guard bands is not practical. In addition, it is difficult to mount a large filter in a small sized mobile terminal apparatus such as a mobile phone, and to determine a direction of antenna of a moving mobile phone.

### SUMMARY

According to an aspect of the invention, a wireless communication system capable of using a plurality of frequency channels in a first predetermined frequency band being adjacent a second predetermined frequency band used in another wireless communication system, the wireless communication system comprises a base station and a mobile station for communicating with wireless communication to the base station; wherein the base station includes a power limit controller for sending a notification for limiting each power of the plurality of frequency channels at the mobile station; and wherein the mobile station includes a transmitter capable of transmitting data to the base station by the use of at least one of the frequency channel in the plurality of frequency channels in the first predetermined frequency band, and a channel controller for decreasing a transmitting power of the frequency channel used in transmitting the data than the transmitting powers of the other frequency channels when the frequency channel for transmitting the data is an adjacent frequency channel of the second predetermined frequency band on the bases of the notification of the power limit controller of the base station, and requesting to change the frequency channel used in transmitting the data to the base station when the frequency channel used in transmitting the data is an adjacent frequency channel of the second predetermined frequency band and the mobile station demands more transmitting power for transmitting the data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic configuration diagram of a mobile phone system of a first embodiment of a communication system.

FIG. 2 is a block diagram of a mobile communication system base station and a mobile terminal apparatus which constitute a mobile terminal system.

FIG. 3 is an illustration illustrating a series of processing sequences in the entire mobile terminal system.

FIG. 4 is an illustration illustrating a series of processing sequences in the entire mobile terminal system when transmitting power of the mobile terminal apparatus becomes smaller than or equal to a limited maximum transmitting power value.

FIG. 5 is an illustration illustrating a series of processing sequences in the mobile communication system base station.

FIGS. 6A and 6B are illustrations illustrating a series of processing sequences in the mobile terminal apparatus.

FIG. 7 is an illustration illustrating a relationship between frequency channels and transmitting power of each frequency channel.

FIG. 8 is an illustration illustrating a relationship between a distance from the mobile communication system base station to the mobile terminal apparatus and a frequency channel Fx selected by the mobile terminal apparatus.

FIG. 9 is an illustration illustrating a relationship between frequency channels and transmitting power of each frequency channel when an ITS system is near the mobile terminal apparatus.

FIG. 10 is an illustration illustrating the frequency channels used by the mobile terminal apparatuses.

FIG. 11 is an illustration illustrating maximum transmitting power of each of the frequency channels F1 to Fn in the mobile terminal system of a third embodiment.

FIG. 12 is an illustration illustrating the frequency channels used by the mobile terminal apparatuses.

FIGS. 13A and 13B are illustrations illustrating a series of processing sequences in the mobile communication system base station.

FIGS. 14A and 14B are illustrations illustrating a series of processing sequences in the mobile terminal apparatus.

FIG. 15 is an illustration illustrating the frequency channels used by the mobile terminal apparatuses in the mobile terminal system of a fourth embodiment.

FIG. 16 is a schematic configuration diagram of the mobile terminal system of a fifth embodiment and adjacent systems thereof.

FIG. 17 is an illustration illustrating a relationship between frequency channels used in the mobile terminal system of the fifth embodiment and transmitting power of each frequency channel.

FIG. 18 is a block diagram of the mobile communication system base station and the mobile terminal apparatus which constitute the mobile terminal system of the fifth embodiment.

FIGS. 19A and 19B are illustrations illustrating a series of processing sequences performed from the mobile communication system base station of the fifth embodiment to the ITS system.

FIGS. 20A and 20B are illustrations illustrating a series of processing sequences performed from the mobile communication system base station to a wireless LAN system.

FIGS. 21A and 21B are illustrations illustrating a series of processing sequences performed from the mobile terminal apparatus to the ITS system.

FIGS. 22A and 22B are illustrations illustrating a series of processing sequences performed from the mobile terminal apparatus to the wireless LAN system.

FIG. 23 is an illustration illustrating maximum transmitting power of each of the frequency channels F1 to Fn when only the ITS system is observed.

FIG. 24 is an illustration illustrating the frequency channels used by the mobile terminal apparatuses when only the ITS system is observed.

FIG. 25 is an illustration illustrating maximum transmitting power of each of the frequency channels F1 to Fn when only the wireless LAN system is observed.

FIG. 26 is an illustration illustrating the frequency channels used by the mobile terminal apparatuses when only the wireless LAN system is observed.

FIG. 27 is an illustration illustrating maximum transmitting power of each of the frequency channels F1 to Fn when both of the ITS system and the wireless LAN system are observed.

FIG. 28 is an illustration illustrating the frequency channels used by the mobile terminal apparatuses when both of the ITS system and the wireless LAN system are observed.

### DESCRIPTION OF EMBODIMENTS

Hereinafter, specific embodiments will be described with reference to the drawings.

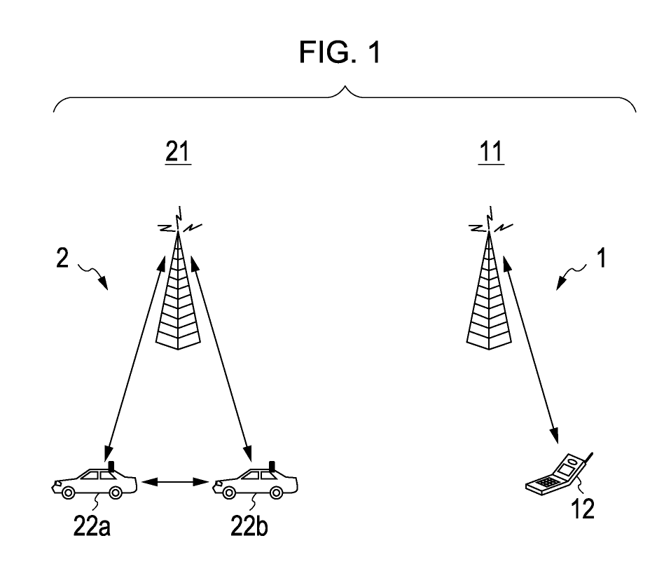

FIG. 1 is a schematic configuration diagram of an embodiment of the above described communication system.

In FIG. 1, a mobile terminal apparatus 12, a mobile terminal system 1 including a mobile communication system base station 11 which performs wireless communication with the mobile terminal apparatus 12, vehicles 22a, 22b, and an ITS system 2 including an ITS base station 21 which performs wireless communication with the vehicles 22a, 22b are illustrated. Actually, a large number of mobile terminal apparatuses and vehicles are connected to the mobile communication system base station 11 and the ITS base station 21. Furthermore, a large number of base stations are connected to each other. In FIG. 1, only elements necessary for the description are illustrated for simplicity of the drawing.

A predetermined frequency band W1 is allocated to the mobile terminal system 1, and wireless communication is performed by using multiple frequency channels F1 to Fn belonging to the frequency band W1. In the mobile communication system base station 11, notification information is transmitted to multiple addresses by using each of the multiple frequency channels F1 to Fn. In each mobile terminal apparatus 12, the notification information is received by using the multiple frequency channels F1 to Fn, and one of the frequency channels is selected in accordance with a radio wave condition. Furthermore, a registration request is transmitted from each mobile terminal apparatus 12 to the mobile communication system base station 11 by using the selected frequency band, and a wireless resource is established. The mobile terminal apparatus 12 corresponds to an example of the above mentioned mobile station apparatus, and the mobile communication system base station 11 corresponds to an example of the above mentioned base station apparatus.

A frequency band W2 (hereinafter called an adjacent frequency band W2) which is adjacent to the frequency band W1 of the mobile terminal system 1 is allocated to the ITS system 2. Wireless communication between the vehicles 22a, 22b and the ITS base station, and wireless communication between the vehicle 22a and the vehicle 22b are performed by using a frequency within the adjacent frequency band W2. The ITS system 2 corresponds to an example of the above mentioned “adjacent separate communication system”.

Since, the frequency bands W1 and W2 which are adjacent to each other are used in the mobile terminal system 1 and the ITS system 2, if a sidelobe of a signal transmitted in the mobile terminal system 1 leaks into the frequency band W2 of the ITS system 2, the sidelobe may interfere with a signal being transmitted in the ITS system 2. In the mobile terminal system 1 of this embodiment, the maximum transmitting power when communicating by using a frequency channel near the frequency band W2 of the ITS system 2 is limited, so that leakage power is reduced.

Hereinafter, the mobile terminal system 1 will be described in detail.

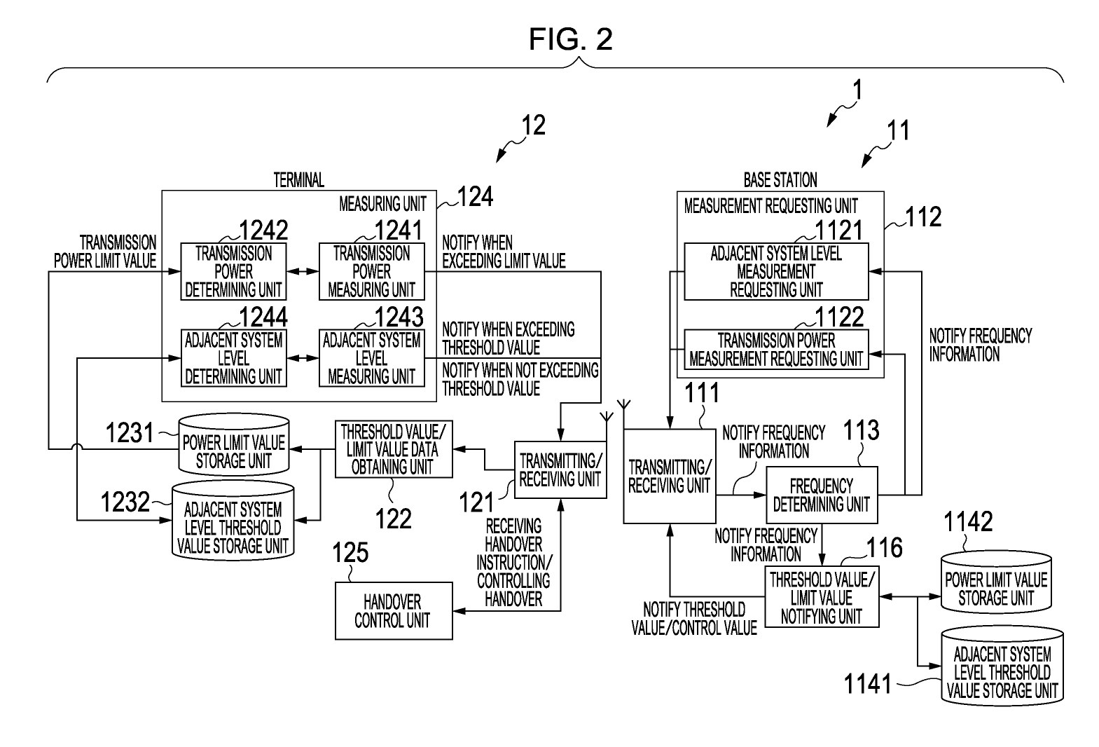

FIG. 2 is a block diagram of the mobile communication system base station 11 and the mobile terminal apparatus 12 constituting the mobile terminal system 1.

The mobile communication system base station 11 includes a transmitting/receiving unit (transceiver) 111 for transmitting/receiving a signal, an adjacent system level measurement requesting unit 1121 for causing the mobile terminal apparatus 12 to measure a radio wave level in the frequency band W2 used by the ITS system 2 adjacent to the mobile terminal apparatus 12, and a transmitting power measurement requesting unit 1122 for causing the mobile terminal apparatus 12 to measure a signal transmitting power. In addition, the mobile communication system base station 11 includes a frequency determining unit 113 for determining a frequency channel used by the mobile terminal apparatus 12 and transmitting the channel information to a measurement requesting unit 112, an adjacent system level threshold value storage unit 1141 for storing a threshold value (hereinafter called an adjacent threshold value) of a radio wave in the frequency band W2, the threshold value determining whether the ITS system is present nearby, a power limit value storage unit 1142 for storing a limit value (hereinafter called a limited maximum transmitting power value) of the transmission electric power of the mobile terminal apparatus 12, and a threshold value notifying unit (power limit controller) 116 for obtaining the limited maximum transmitting power value and the adjacent threshold value and transmitting these values to the transmitting/receiving unit 111.

The mobile terminal apparatus 12 includes a transmitting/receiving unit (transceiver) 121 for transmitting/receiving a signal, a threshold value/limit value obtaining unit (channel controller) 122 for obtaining various threshold values transmitted from the mobile communication system base station 11 via the transmitting/receiving unit 121, a power limit value storage unit 1231 for storing the limited maximum transmitting power value obtained by the threshold value/limit value obtaining unit 122, and an adjacent system level threshold value storage unit 1232 for storing the adjacent threshold value obtained by the threshold value/limit value obtaining unit 122. In addition, a transmitting power measuring unit 1241 for measuring a signal transmitting power according to a request, a transmitting power determining unit 1242 for determining whether the transmitting power measured by the transmitting power measuring unit 1241 exceeds the limited maximum transmitting power value stored in the power limit value storage unit 1231 or not, an adjacent system level measuring unit 1243 for measuring a radio wave level in the adjacent frequency band W2 according to a request, an adjacent system level determining unit 1244 for determining whether the power level measured by the adjacent system level measuring unit 1243 exceeds the adjacent threshold value stored in the adjacent system level threshold value storage unit 1232 or not, and a handover control unit 125 for switching the frequency channel. The transmitting/receiving unit 121 corresponds to an example of the transmitting unit in the above mentioned communication system, and the handover control unit 125 corresponds to an example of the channel control unit in the above mentioned communication system.

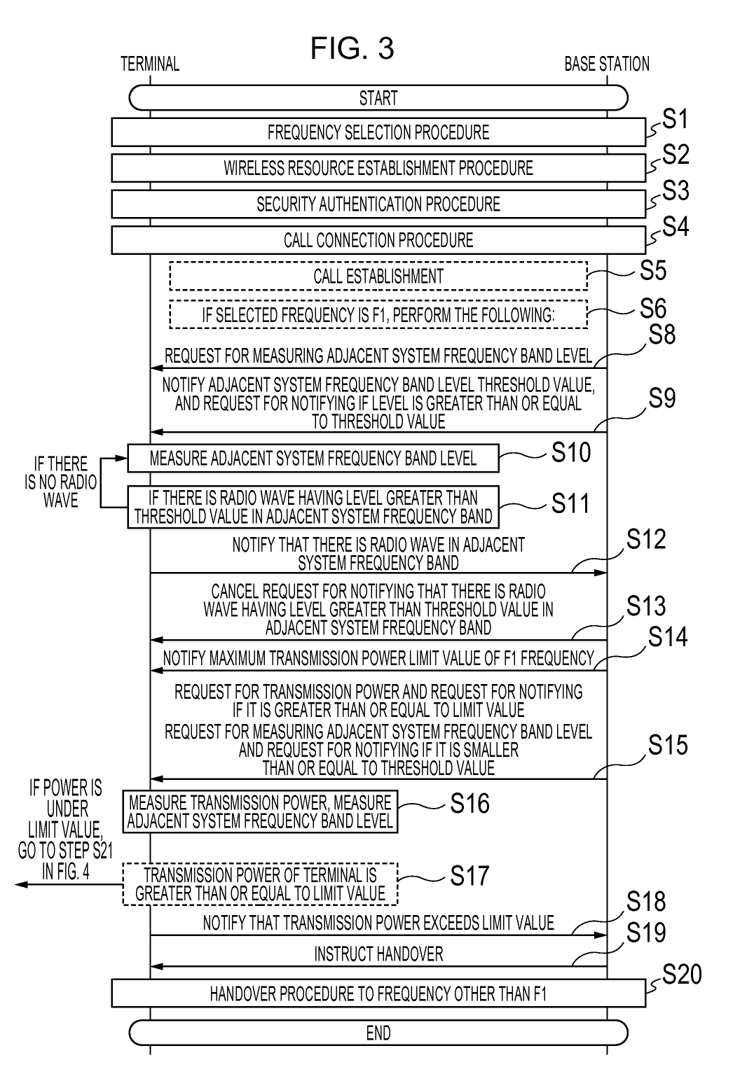

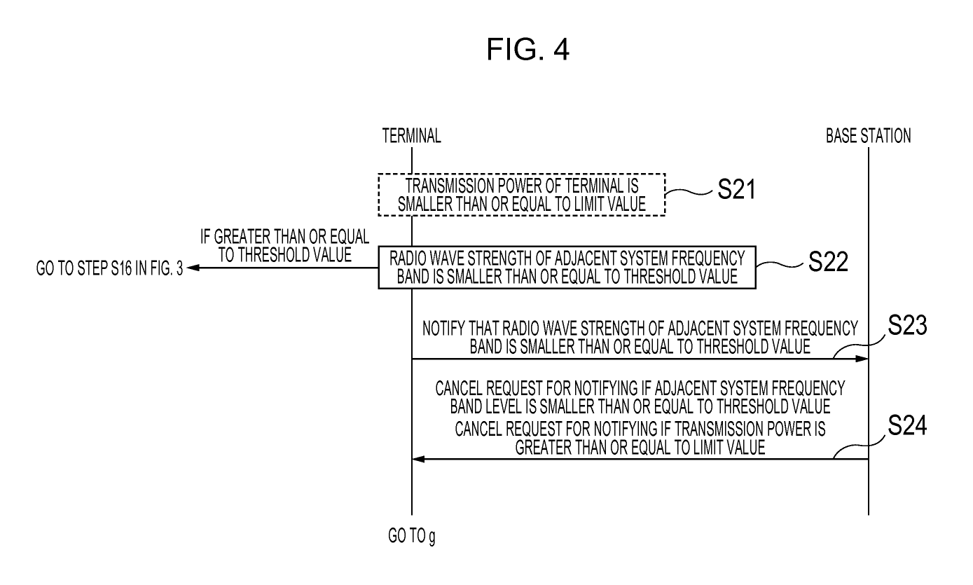

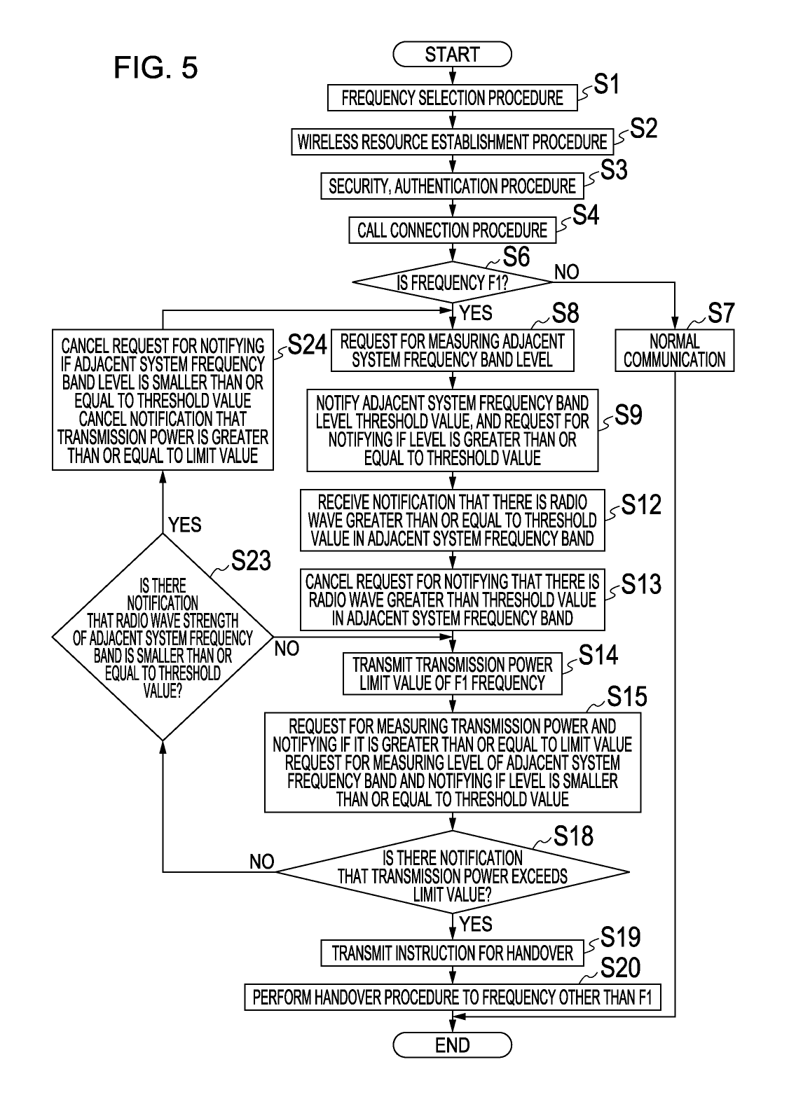

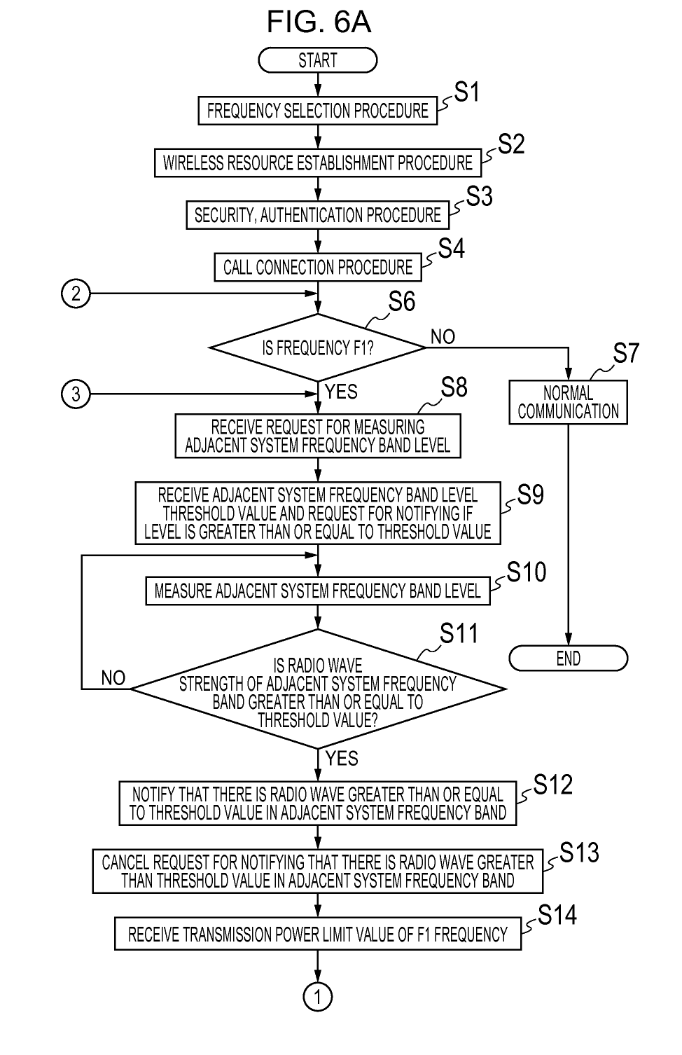

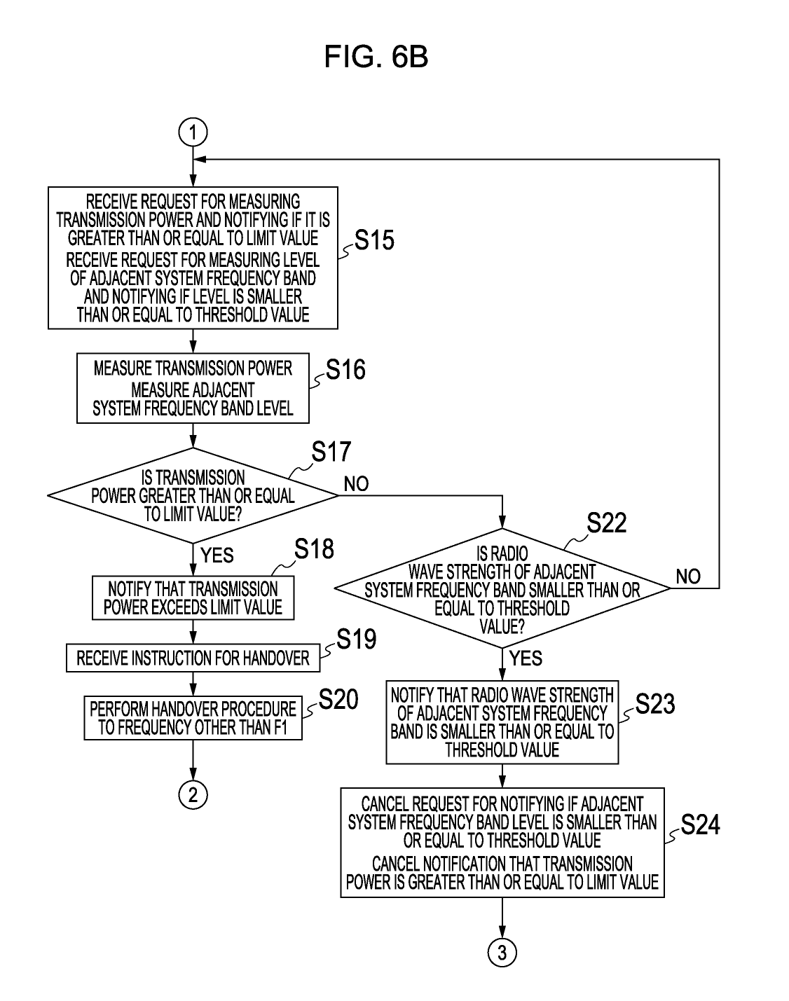

FIGS. 3 and 4 are illustrations illustrating a series of processing sequences in the entire mobile terminal system 1, FIG. 5 is an illustration illustrating a series of processing sequences in the mobile communication system base station 11, and FIGS. 6A and 6B are illustrations illustrating a series of processing sequences in the mobile terminal apparatus 12.

In FIGS. 3, 4, 5, 6A and 6B, the same reference number is attached to the same processing, and each processing will be described once.

To perform communication, first, a frequency channel is selected (step S1 in FIG. 3). The frequency band W1 is allocated to the mobile terminal system 1, and multiple frequency channels F1 to Fn belonging to the frequency band W1 are prepared.

In the mobile communication system base station 11, the notification information is transmitted to multiple addresses by the transmitting/receiving unit 111 using the multiple frequency channels F1 to Fn (step S1 in FIG. 5).

In the transmitting/receiving unit 121 of the mobile terminal apparatus 12, the notification information in each of the multiple frequency channels F1 to Fn is received, and in the handover control unit 125, the frequency channel being received at the highest level is selected from the frequency channels F1 to Fn (step S1 in FIG. 6A).

When one frequency channel Fx is selected from the frequency channels F1 to Fn, a wireless resource for performing wireless communication between the mobile communication system base station 11 and the mobile terminal apparatus 12 is established (step S2 in FIGS. 3, 5, 6A), and transfer of a secret key for security and the like is performed (step S3 in FIGS. 3, 5, 6A).

When authentication of the mobile terminal 12 is completed, a call connection procedure between the mobile communication system base station 11 and the mobile terminal apparatus 12 is performed (step S4 in FIGS. 3, 5, 6A), and the call connection using the selected frequency channel Fx is established (step S5 in FIG. 3).

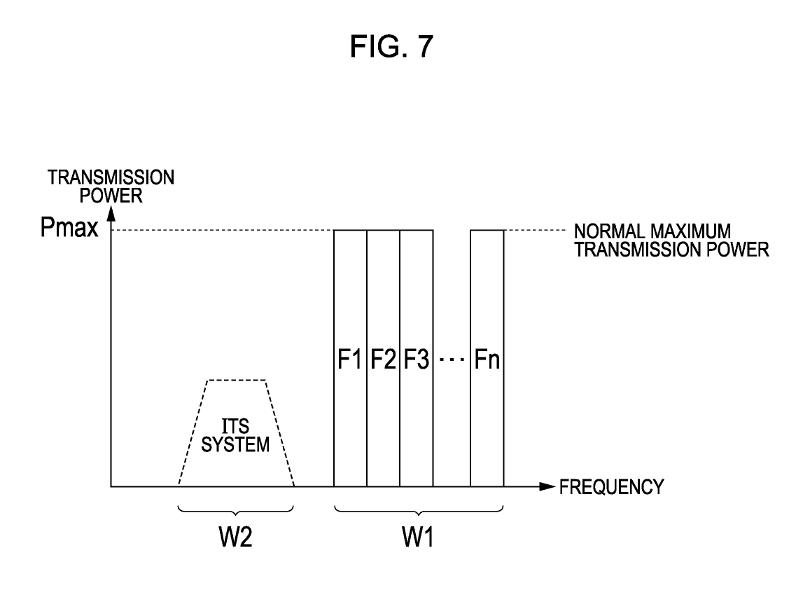

FIG. 7 is an illustration illustrating a relationship between frequency channels and the transmitting power of each frequency channel.

As illustrated in FIG. 7, for example, multiple frequency channels F1 to Fn belonging to the frequency band W1 are prepared for the mobile terminal system 1. When there is no ITS system 2 nearby, it is possible to use transmitting power up to the maximum transmitting power Pmax in each frequency channel F1 to Fn. When there is the ITS system 2, communication is performed by using the adjacent frequency band W2 in the ITS system 2, and the frequency channel F1 of the mobile terminal system 1 is adjacent to the adjacent frequency band W2. Hereinafter, the frequency channel F1 is called an adjacent channel F1.

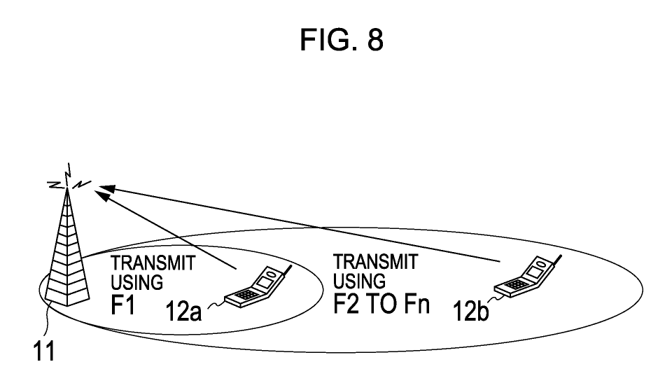

FIG. 8 is an illustration illustrating a relationship between the distance from the mobile communication system base station 11 to the mobile terminal apparatus 12 and the frequency channel Fx selected by the mobile terminal apparatus 12.

As illustrated in FIG. 8, in this embodiment, the transmitting power and the like of the notification information transmitted from the mobile communication system base station 11 by using each of the frequency channels F1 to Fn are controlled, so that the adjacent channel F1 is selected by the mobile terminal 12a located in an area (inside area) inside a cell which is near the mobile communication system base station 11 and is presumed to have a good radio wave condition. The other frequency channels F2 to Fn other than the adjacent channel F1 are selected by the mobile terminal apparatus 12b located in an area (outside area) outside the cell, the outside area being apart from the mobile communication system base station 11 and being presumed to have an inferior radio wave condition compared with a center area. Although an example in which the radio wave condition changes in accordance with the distance from the mobile communication system base station 11 is described here, since the radio wave condition also changes depending on buildings nearby and weather, it is not necessarily the case that the adjacent channel F1 is selected in the inside area and the other frequency channels F2 to Fn other than the adjacent channel F1 are selected in the outside area.

Here, when the frequency channel Fx selected by the mobile terminal apparatus 12 is not the adjacent channel F1 (step S6 in FIGS. 3, 5, 6A: No), normal wireless communication is performed between the mobile communication system base station 11 and the mobile terminal apparatus 12 by using the frequency channel Fx (step S7 in FIGS. 5, 6A). At this time, it is possible to use transmitting power up to the maximum transmitting power Pmax when transmitting information from the mobile terminal apparatus 12 to the mobile communication system base station 11.

When the frequency channel Fx selected by the mobile terminal apparatus 12 is the adjacent channel F1 (step S6 in FIGS. 3, 5, 6A: Yes), an adjacent system level measurement request for measuring a radio wave level within the adjacent frequency band W2 allocated to the ITS system 2 is transmitted from the mobile communication system base station 11 to the mobile terminal apparatus 12 (step S8 in FIG. 3). Also, the adjacent threshold value and a reply notification request generated when the measured radio wave level is greater than or equal to the threshold value are transmitted (step S9 in FIG. 3).

Frequency information representing the frequency channel used by the mobile terminal apparatus 12 is transmitted from the frequency determining unit 113 of the mobile communication system base station 11 to the measurement requesting unit 112 and the threshold value notifying unit 116, and the adjacent system level measurement request is transmitted by the adjacent system level measurement requesting unit 1121 (step S8 in FIG. 5). The reply notification request is transmitted by the threshold value notifying unit 116 (step S9 in FIG. 5).

The adjacent system level measurement request transmitted from the mobile communication system base station 11 is received by the transmitting/receiving unit 121 of the mobile terminal apparatus 12, and transferred to the adjacent system level measuring unit 1243 (step S9 in FIG. 6A). The adjacent threshold value and the reply notification request transmitted from the mobile communication system base station 11 are received by the transmitting/receiving unit 121, and transferred to the threshold value/limit value obtaining unit 122 (step S9 in FIG. 6A). The adjacent threshold value is stored in the adjacent system level threshold value storage unit 1232.

Next, in the adjacent system level measuring unit 1243 of the mobile terminal apparatus 12, in response to the adjacent system level measurement request, the radio wave level in the frequency band W2 used by the ITS system 2 is measured (step S10 in FIGS. 3, 6A). As a method for measuring a radio wave level in a frequency band of another system, for example, a method for measuring a GSM level by a compressed mode of the 3GPP standard can be applied. The measured radio wave level is transmitted to the adjacent system level determining unit 1244.

In the adjacent system level determining unit 1244, the measured radio wave level in the adjacent frequency band W2 and the adjacent threshold value stored in the adjacent system level threshold value storage unit 1232 are compared. When the radio wave level in the adjacent frequency band W2 is smaller than the adjacent threshold value (step S11 in FIGS. 3, 6A: No), it indicates that, at this time, there is no vehicle, such as vehicles 22a, 22b of the ITS system, and the like near the mobile terminal apparatus 12, and the measurement is repeated until the radio wave level reaches the adjacent threshold value (step S10 in FIGS. 3, 6A). When the radio wave level in the adjacent frequency band W2 reaches a level greater than or equal to the adjacent threshold value (step S11 in FIGS. 3, 6A: Yes), there are vehicles 22a, 22b of the ITS system, and the like near the mobile terminal apparatus 12. Therefore, a reply notification indicating that the radio wave level exceeds the adjacent threshold value is transmitted to the mobile communication system base station 11 (step S12 in FIGS. 3, 6A).

When the reply notification transmitted from the mobile terminal apparatus 12 is received by the mobile communication system base station 11 (step S12 in FIG. 5), a cancel instruction of the reply notification request is transmitted to the mobile terminal apparatus 12 (step S13 in FIGS. 3, 5). The limited maximum transmitting power value stored in the power limit value storage unit 1142 is also transmitted (step S14 in FIGS. 3, 5).

In the mobile terminal apparatus 12, the cancel instruction of the reply notification request and the limited maximum transmitting power value transmitted from the mobile communication system base station 11 are received (step S13 in FIG. 6A). The limited maximum transmitting power value is stored in the power limit value storage unit 1231 (step S14 in FIG. 6A).

Furthermore, in the mobile communication system base station 11, a transmitting power measurement request and a reply notification request generated when the transmitting power is greater than or equal to the limited maximum transmitting power value are transmitted by the transmitting power measurement requesting unit 1122. The adjacent system level measurement request and a reply notification request generated when the radio wave level in the frequency band W2 used by the ITS system 2 decreases to a level smaller than or equal to the adjacent threshold value are transmitted by the adjacent system level measurement requesting unit 1121 (step S15 in FIGS. 3, 5).

In the mobile terminal apparatus 12, the transmitting power measurement request, the reply notification request corresponding to the transmitting power, the adjacent system level measurement request, and the reply notification request corresponding to the adjacent system which are transmitted from the mobile communication system base station 11 are received (step S15 in FIG. 6B). In the transmitting power measuring unit 1241, in response to the transmitting power measurement request, the transmitting power when transmitting information is measured, and in the adjacent system level measuring unit 1243, in response to the adjacent system level measurement request, the radio wave level in the frequency band W2 used by the ITS system 2 is measured (step S16 in FIGS. 3, 6B). Furthermore, in the transmitting power determining unit 1242, when it is determined that the measured transmitting power exceeds the limited maximum transmitting power value stored in the power limit value storage unit 1231 (step S17 in FIGS. 3, 6B: Yes), a reply notification indicating that the transmitting power exceeds the limited maximum transmitting power value is transmitted to the mobile communication system base station 11 (step S18 in FIGS. 3, 6B).

When receiving the reply notification of the transmitting power (step S18 in FIG. 5: Yes), the mobile communication system base station 11 transmits a handover instruction to the mobile terminal apparatus 12 (step S19 in FIGS. 3, 5).

The handover control unit 125 of the mobile terminal apparatus 12 receives the handover instruction (step S19 in FIG. 6B), and selects the frequency channel Fx having the smallest amount of traffic from among the multiple frequency channels F2 to Fn other than the adjacent channel F1. When the new frequency channel Fx is selected, a handover procedure to the selected frequency channel Fx is performed (step S20 in FIGS. 3, 5, 6B).

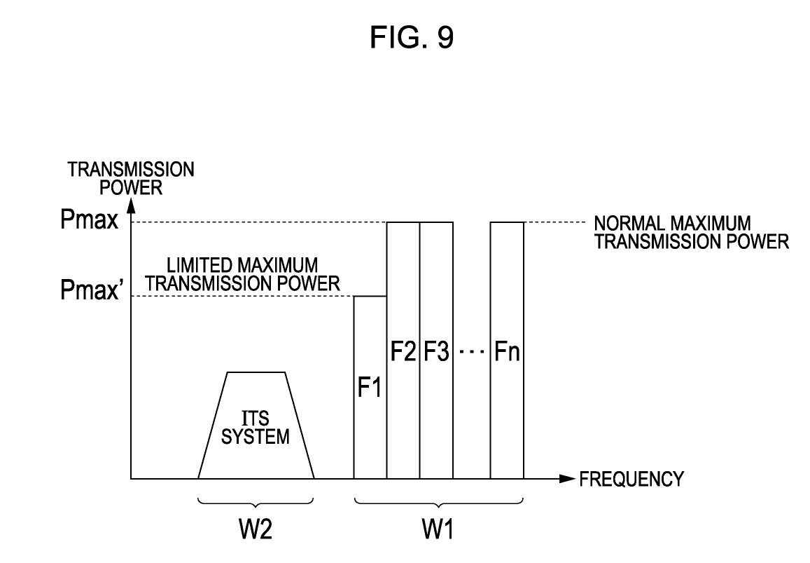

FIG. 9 is an illustration illustrating a relationship between frequency channels and the transmitting power of each frequency channel when the ITS system 2 is near the mobile terminal apparatus 12.

When the radio wave level in the adjacent frequency band W2 measured by the mobile terminal apparatus 12 exceeds the adjacent threshold value, it is presumed that there are vehicles 22a, 22b of the ITS system near the mobile terminal apparatus 12. However, as illustrated in FIG. 9, since the maximum transmitting power of the adjacent channel F1 adjacent to the adjacent frequency band W2 of the ITS system 2 is limited to a limited Pmax′ smaller than the normal maximum transmitting power Pmax, interference with the ITS system 2 can be reduced.

Here, an application embodiment of the above described basic embodiment of the communication system is preferred. In the application embodiment, when a frequency channel used by the transmitting unit is a power limited frequency channel and a transmission requiring transmitting power higher than the limit value is needed, the channel control unit compares amounts of traffic in frequency channels in which transmission is possible using power higher than the transmitting power of the currently used frequency channel, and instructs the transmitting unit to use the frequency channel having the smallest amount of traffic from among the frequency channels in which transmission is possible using power higher than the transmitting power of the currently used frequency channel.

In this embodiment, when performing communication using the adjacent channel F1, if transmitting power greater than the limit value Pmax′ is needed, a handover is performed so that the frequency channel is changed to the frequency channel having the smallest amount of traffic from among the frequency channels F2 to Fn that are able to use the maximum transmitting power Pmax. Therefore, processing loads can be distributed to each of the frequency channels F2 to Fn.

FIG. 4 illustrates a series of processing sequences in the entire mobile terminal system 1 when the transmitting power of the mobile terminal apparatus 12 becomes smaller than or equal to the limited maximum transmitting power value.

When the transmitting power of the mobile terminal apparatus 12 becomes smaller than or equal to the limited maximum transmitting power value (step S21 in FIGS. 4, 6B: No), the reply notification of the transmitting power is not transmitted to the mobile communication system base station 11 (step S18 in FIG. 6B: No). At this time, the radio wave level in the adjacent frequency band W2 is measured in the adjacent system level measuring unit 1243 of the mobile terminal apparatus 12. When the radio wave level in the adjacent frequency band W2 is greater than the adjacent threshold value (step S22 in FIGS. 4, 6B: No), the measurement of the radio wave level in the adjacent frequency band W2 and the measurement of the transmitting power of the mobile terminal apparatus 12 are repeated until the transmitting power becomes greater than the limited maximum transmitting power value and the handover is performed in the mobile terminal apparatus 12 or the radio wave level in the adjacent frequency band W2 becomes smaller than or equal to the adjacent threshold value.

When the radio wave level in the adjacent frequency band W2 becomes smaller than or equal to the adjacent threshold value (step S22 in FIGS. 4, 6B: Yes), it indicates that the vehicles 22a, 22b of the ITS system have moved away from the mobile terminal apparatus 12. At this time, a reply notification indicating that the radio wave level in the adjacent frequency band W2 becomes smaller than or equal to the adjacent threshold value is transmitted to the mobile communication system base station 11 (step S23 in FIGS. 4, 5, 6B). Cancellation of various reply notification requests is instructed from the mobile communication system base station 11 to the mobile terminal apparatus 12 (step S24 in FIGS. 4, 5, 6B).

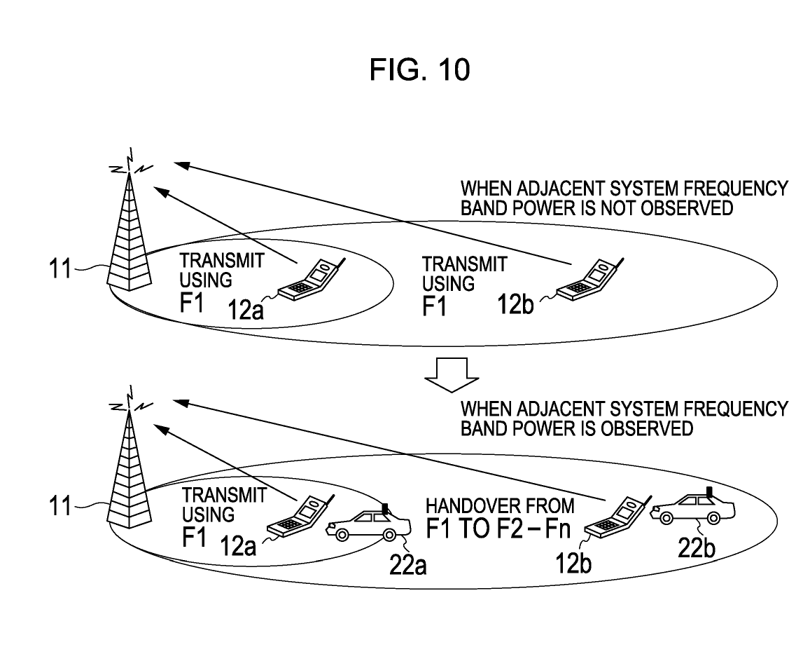

FIG. 10 is an illustration illustrating the frequency channels used by the mobile terminal apparatuses 12.

When the radio wave level in the adjacent frequency band W2 is smaller than the adjacent threshold value and the vehicles 22a, 22b of the ITS system are not near the mobile terminal apparatus 12, each mobile terminal apparatus 12 selects a frequency channel having the best radio wave condition from the multiple frequency channels F1 to Fn and performs communication. At this time, as illustrated in FIG. 7, transmitting power up to the maximum transmitting power Pmax can be used also in the adjacent channel F1 in the same way as the other frequency channels F2 to Fn.

When the radio wave level in the adjacent frequency band W2 exceeds the adjacent threshold value and the vehicles 22a, 22b of the ITS system are near the mobile terminal apparatus 12, as illustrated in FIG. 9, maximum transmitting power when using the adjacent channel F1 to transmit information is limited to the limited maximum transmitting power value Pmax′. For example, the mobile terminal apparatus 12a located in an area where the radio wave condition is good performs communication using the adjacent channel F1 without change because the transmitting power does not exceeds the limited maximum transmitting power value. In the mobile terminal apparatus 12b located in an area where the radio wave condition is not good, a handover is performed so that the frequency channel is changed to the frequency channels F2 to Fn that are able to use the maximum transmitting power Pmax because the transmitting power exceeds the limited maximum transmitting power value.

Here, an application embodiment of the above described basic embodiment of the communication system is preferred. In the application embodiment, the mobile station apparatus includes an adjacent system level measuring unit for measuring electric power of a second communication frequency band used in another communication system adjacent to a first communication frequency band, and an electric power limiting unit of the base station apparatus limits the maximum transmitting power of a power limited frequency channel on the basis of the electric power value measured by the adjacent system level measuring unit.

The maximum transmitting power of the power limited frequency channel is limited only when interference with another system is expected, so that wireless resource can be efficiently used.

As described above, according to this embodiment, the maximum transmitting power of the frequency channel F1 adjacent to the frequency band W2 of the ITS system 2 is limited, so that interference with the ITS system 2 can be reduced without mounting a large filter and the like in the mobile terminal apparatus 12.

Here, the description of the first embodiment is completed, and the second embodiment will be described. Although a mobile terminal system 1_2 of the second embodiment has an approximately the same configuration as the first embodiment, a frequency channel selection method when the handover is performed is different from that of the first embodiment. Therefore, only the differences from the first embodiment will be described.

In step S20 in FIGS. 3, 5, 6B, the mobile terminal system 1 of the first embodiment selects the frequency channel Fx having the smallest amount of traffic from among the multiple frequency channels F2 to Fn other than the adjacent channel F1. In the mobile terminal system 1_2 of this embodiment, the frequency channel Fx having an available resource and being nearest to the adjacent channel F1 from the multiple frequency channels F2 to Fn other than the adjacent channel F1 is selected.

As illustrated in FIG. 9, in this embodiment, since only the adjacent channel F1 cannot use fully the maximum transmitting power Pmax, the other frequency channels F2 to Fn can use the maximum transmitting power Pmax. In the mobile terminal system 1 of the first embodiment, since when electric power greater than or equal to the limited maximum transmitting power value Pmax′ is required during use of the adjacent channel F1, the frequency channel having the smallest amount of traffic is selected from the other frequency channels F2 to Fn, the processing load is distributed to all the frequency channels F2 to Fn. In the mobile terminal system 1_2 of this embodiment, first, the frequency channel F2 that is nearest to the adjacent channel F1 is selected. When the frequency channel F2 has used all the available resources, the frequency channel F3 that is second nearest to the adjacent channel F1 is selected, and in the same way, the frequency channels F4 to Fn are selected in sequential order. Therefore, in the frequency channel Fn and the like far away from the adjacent channel F1, a large available resource remains. Consequently, when a large amount of information is emergently transmitted/received, communication reliability can be improved by allocating the frequency channel Fn having enough resources.

Here, the description of the second embodiment is completed, and the third embodiment will be described. A mobile terminal system 1_3 of the third embodiment is different from that of the first embodiment in that the maximum transmitting power of each of the frequency channels F1 to Fn is fixed in advance. Therefore, only the differences from the first embodiment will be described.

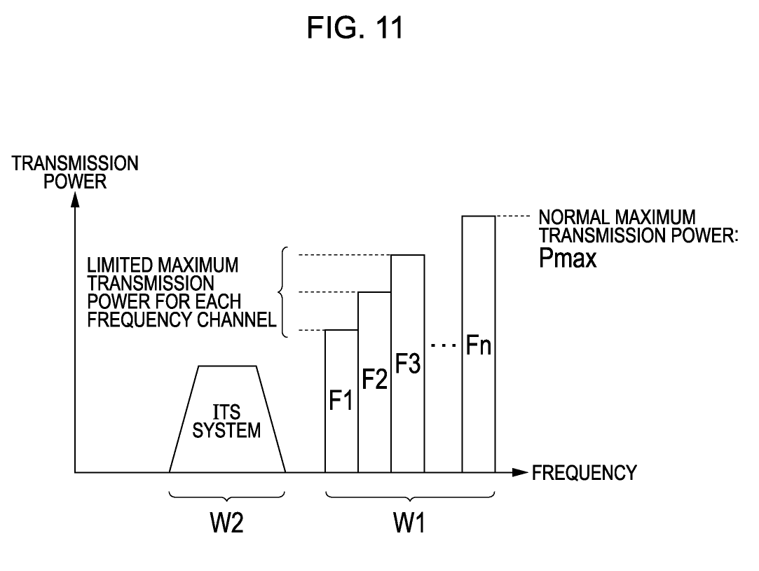

FIG. 11 is an illustration illustrating the maximum transmitting power of each of the frequency channels F1 to Fn in the mobile terminal system 1_3 of the third embodiment.

As illustrated in FIG. 11, in the mobile terminal system 1_3 of the third embodiment, the maximum transmitting power of each of the frequency channels F1 to Fn is more largely limited as it gets closer to the frequency band W2 of the ITS system 2.

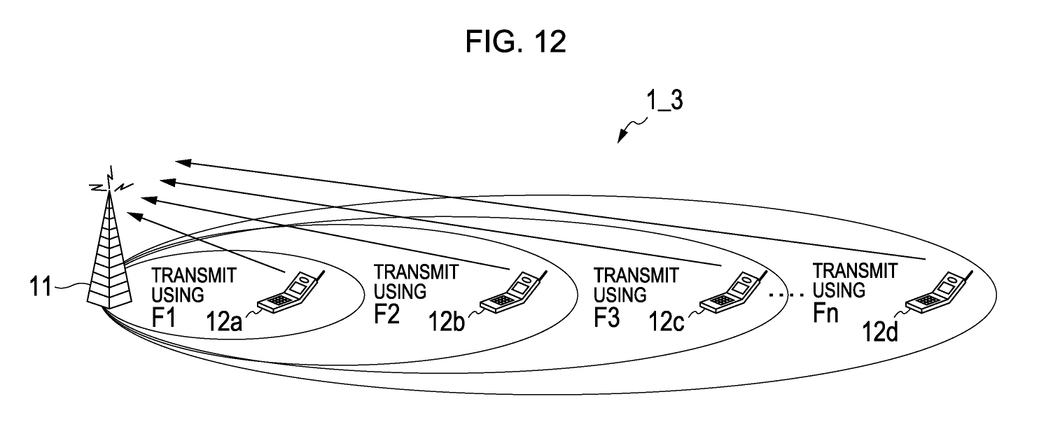

FIG. 12 is an illustration illustrating the frequency channels used by the mobile terminal apparatuses 12.

In this embodiment, in the mobile terminal apparatuses 12a, 12b, 12c, 12d, the maximum transmitting power of each of the frequency channels F1 to Fn is stored in advance. The mobile terminal apparatuses 12a, 12b, 12c, 12d receive the notification information transmitted from the mobile communication system base station 11 by using the frequency channels F1 to Fn. In these frequency channels, a frequency channel having the best radio wave condition is selected, and communication is performed by using the selected frequency channel.

Here, an application embodiment of the above described basic embodiment of the communication system is preferred. In the application embodiment, when there are multiple power limited frequency channels within the first communication frequency band, the electric power limiting unit limits the maximum transmitting power of the multiple power limited frequency channels to a lower limited value as the power limited frequency channel gets closer to the end of the band.

Normally, in an area nearer to the mobile communication system base station 11, the radio wave condition is better and a large transmitting power is not required. Therefore, as illustrated in FIG. 12, it is more possible that the mobile terminal apparatus 12a located in an area more closely to the mobile communication system base station 11 selects the frequency channel F1 whose transmitting power is largely limited. When transmitting power exceeding the maximum transmitting power of the selected frequency channel F1 is required, a handover is performed so that the frequency channel is changed to another frequency channel F2 to Fn having larger maximum transmitting power. In this way, by limiting more largely the maximum transmitting power of each of the frequency channels F1 to Fn as the frequency channel gets closer to the adjacent frequency band W2, the interference to the ITS system 2 can be surely decreased and wireless resources can be effectively used.

An application embodiment of the above described basic embodiment of the communication system is preferred. In the application embodiment, the electric power limiting unit uses a fixed value of the maximum transmitting power when transmission is performed by using the power limited frequency channel.

Since the maximum transmitting power is limited to a fixed value, the control of the transmitting power becomes easy.

Here, the description of the third embodiment is completed, and the fourth embodiment will be described. Since a mobile terminal system of the fourth embodiment has an approximately the same configuration as the first embodiment, FIG. 2 is also used in the fourth embodiment, and only the differences from the first embodiment will be described.

Also in the mobile terminal system 1_4 of this embodiment, like the third embodiment illustrated in FIG. 11, the maximum transmitting power of each of the frequency channels F1 to Fn is more largely limited as it gets closer to the adjacent frequency band W2 of the ITS system 2.

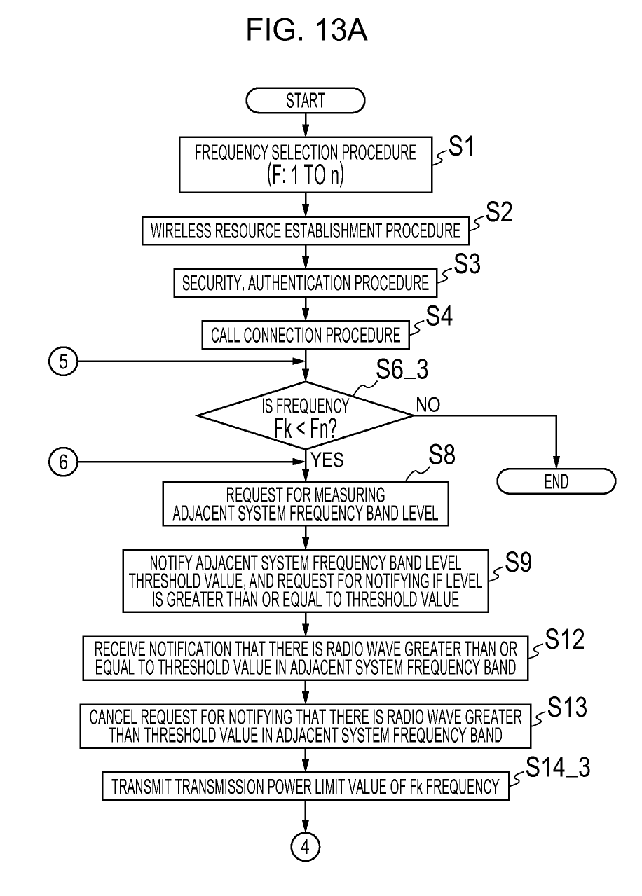

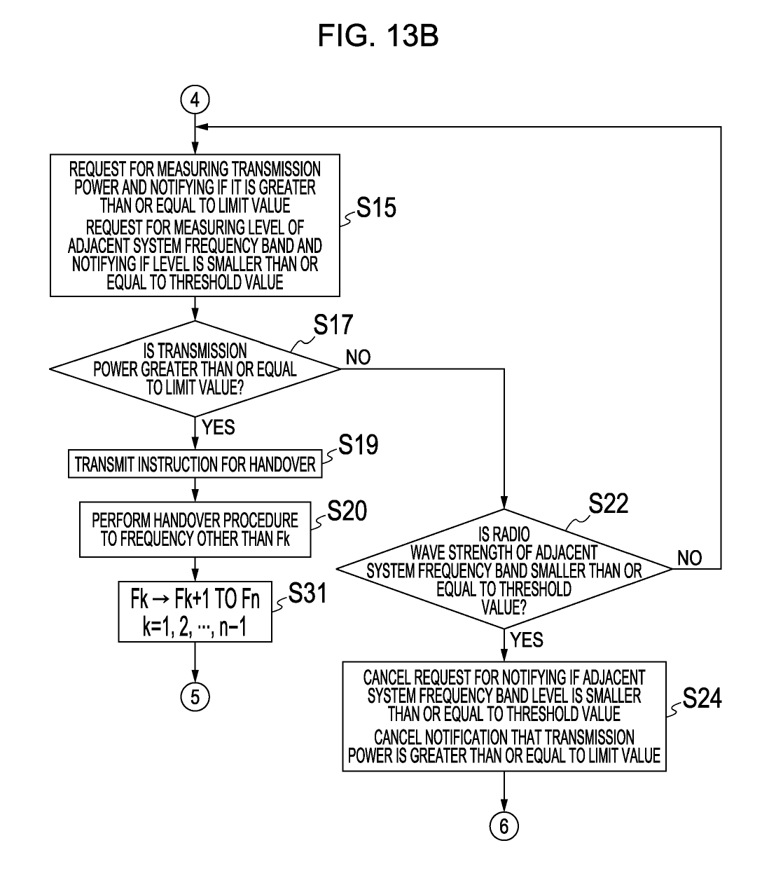

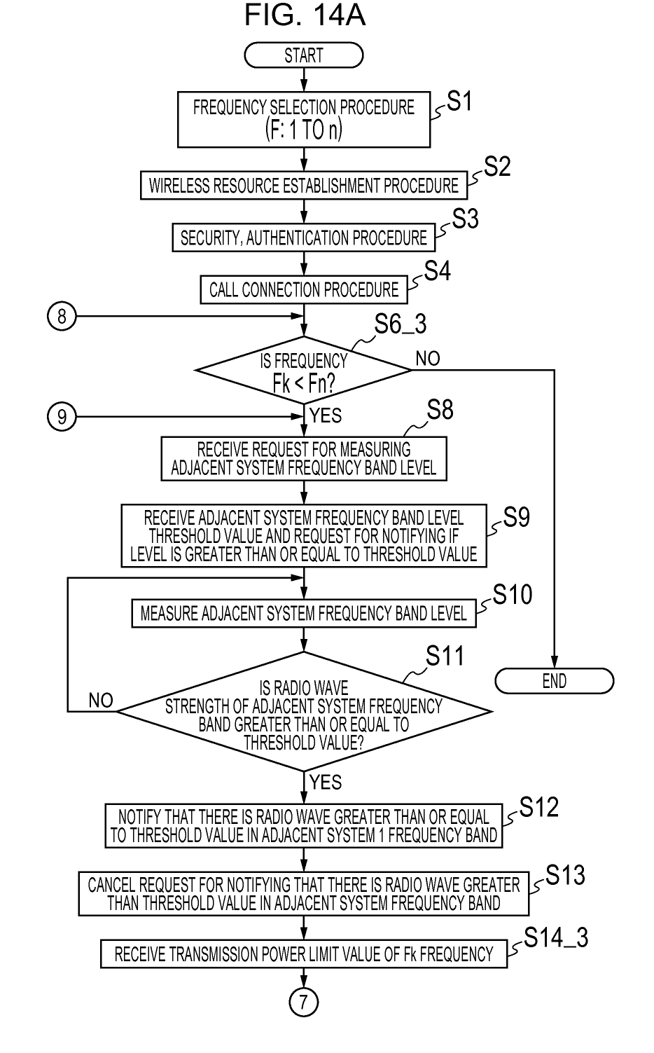

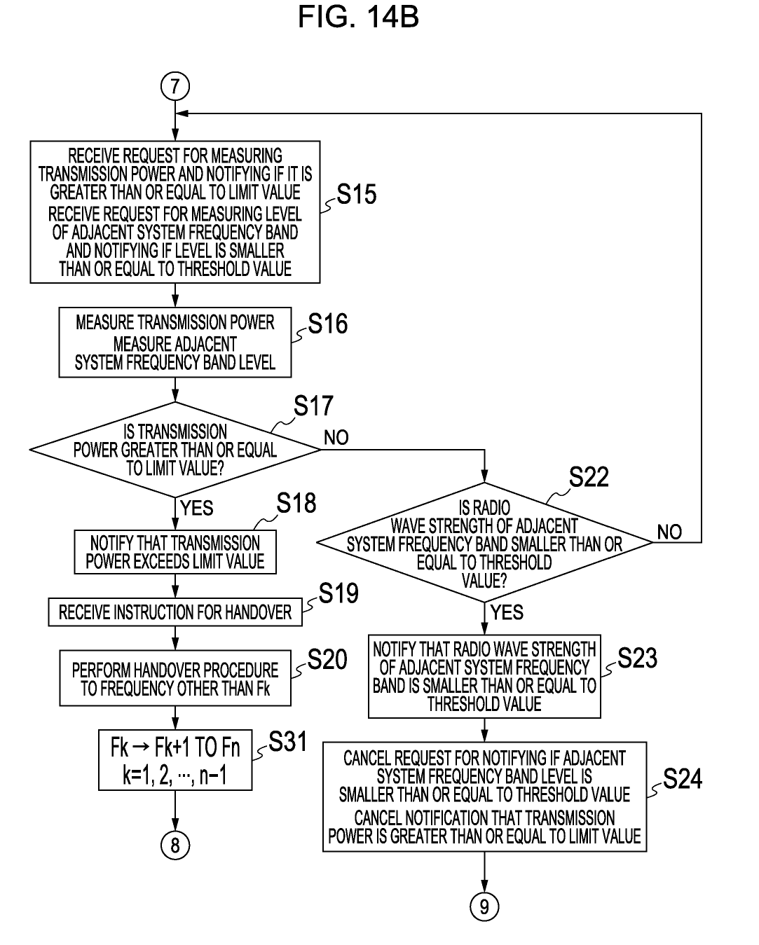

FIGS. 13A and 13B are illustrations illustrating a series of processing sequences in the mobile communication system base station 11, and FIGS. 14A and 14B are illustrations illustrating a series of processing sequences in the mobile terminal apparatus 12.

In FIGS. 13A, 13B, 14A and 14B, the same reference number is attached to the same processing of FIGS. 5, 6A and 6B used in the first embodiment.

First, in the mobile communication system base station 11, the notification information is transmitted to multiple addresses by using the multiple frequency channels F1 to Fn (step S1 in FIG. 13A). In the mobile terminal apparatus 12, a frequency channel being received at the highest level is selected from the frequency channels F1 to Fn (step S1 in FIG. 14).

Next, a wireless resource is established between the mobile communication system base station 11 and the mobile terminal apparatus 12 (step S2 in FIGS. 13A, 14A), authentication of the mobile terminal apparatus 12 is performed (step S3 in FIGS. 13A, 14A), and thereafter a call connection procedure is performed (step S4 in FIGS. 13A, 14A).

When the selected frequency channel Fx is not the frequency channel Fn having the maximum transmitting power with the least limitation illustrated in FIG. 11 and having a maximum allowable transmitting power (step S6_3 in FIGS. 13A, 14A: No), in the same way as the embodiment 1, a request for measuring the radio wave level in the adjacent frequency band W2 is transmitted from the mobile communication system base station 11 to the mobile terminal apparatus 12 (step S8 in FIGS. 13A, 14A). And, a request to notify if the radio wave level is greater than or equal to the threshold value is transmitted (step S9 in FIG. 13A).

In the mobile terminal apparatus 12, the radio wave level in the adjacent frequency band W2 is measured (steps S10, S11 in FIG. 14). When the radio wave level in the adjacent frequency band W2 reaches a level greater than or equal to the adjacent threshold value (step S11 in FIGS. 14: Yes), a reply notification indicating that the radio wave level is greater than or equal to the adjacent threshold value is transmitted to the mobile communication system base station 11 (step S12 in FIGS. 13A, 14A).

When the reply notification is received in the mobile communication system base station 11, the reply notification request is canceled (step S13 in FIGS. 13A, 14A). And the limited maximum transmitting power value corresponding to the selected frequency channel Fx is transmitted to the mobile terminal apparatus 12 (step S14_3 in FIGS. 13A, 14A). The limited maximum transmitting power value of each of the multiple frequency channels F1 to Fn is transmitted from the mobile communication system base station 11 to the mobile terminal apparatus 12, so that the maximum transmitting power of each of the frequency channels F1 to Fn can be easily controlled even when the adjacent channel changes due to addition of a base station and the like.

In addition, in the mobile communication system base station 11, the transmitting power measurement request, the adjacent system level measurement request, the reply notification request of the transmitting power, and the reply notification request of the adjacent radio wave level are transmitted (step S15 in FIGS. 13B, 14B). In the mobile terminal apparatus 12, the transmitting power and the radio wave level in the adjacent frequency band W2 are measured (step S16 in FIG. 14B).

When the transmitting power is smaller than the limited maximum transmitting power value (step S17 in FIGS. 13B, 14B: No), if the radio wave level of the adjacent frequency band W2 is greater than the adjacent threshold value (step S22 in FIGS. 13B, 14B: No), the transmitting power becomes greater than the limited maximum transmitting power value, and a handover is performed in the mobile terminal apparatus 12. Or, the measurements of the radio wave level and the transmitting power are repeated until the radio wave level in the adjacent frequency band W2 becomes smaller than or equal to the adjacent threshold value. When the radio wave level in the adjacent frequency band W2 becomes smaller than or equal to the adjacent threshold value (step S22 in FIGS. 13B, 14B: Yes), the mobile communication system base station 11 is notified that the radio wave level becomes smaller than or equal to the adjacent threshold value from the mobile terminal apparatus 12 (step S23 in FIG. 14B), and various reply notification requests are cancelled (step S24 in FIGS. 13B, 14B).

When the measured transmitting power exceeds the limited maximum transmitting power value (step S17 in FIGS. 13B, 14B: Yes), the mobile communication system base station 11 is notified that the transmitting power exceeds the limited maximum transmitting power value from the mobile terminal apparatus 12 (step S18 in FIG. 14B). Next, the handover instruction is transmitted from the mobile communication system base station 11 to the mobile terminal apparatus 12 (step S19 in FIGS. 13B, 14B). In the mobile communication system base station 11, a handover procedure to the frequency channels F(x+1) to Fn having the limited maximum transmitting power value smaller (larger) than that of the selected frequency channel Fx is performed (step S20 in FIGS. 13B, 14B).

When the handover is completed (step S31 in FIGS. 13B, 14B), concerning the newly selected frequency channel, the measurement of the transmitting power, the measurement of the radio wave level of the adjacent frequency band W2, and the like are repeated.

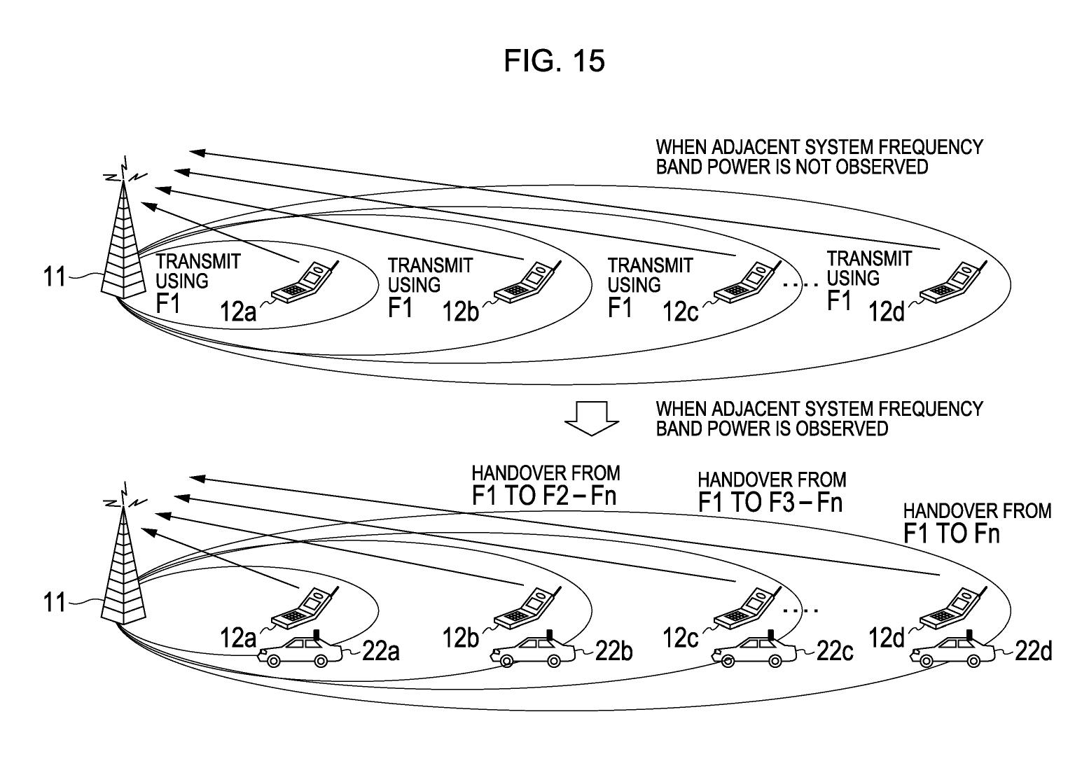

FIG. 15 is an illustration illustrating the frequency channels used by the mobile terminal apparatuses 12 in the mobile terminal system 1_4 of the fourth embodiment.

Also in the mobile terminal system 1_4 of this embodiment, when there are not the vehicles 22a, 22b, 22c, 22d of the ITS system near the mobile terminal apparatuses 12a, 12b, 12c, 12d, each of the mobile terminal apparatuses 12a, 12b, 12c, 12d selects a frequency channel having the best radio wave condition from the multiple frequency channels F1 to Fn and performs communication.

When there are the vehicles 22a, 22b, 22c, 22d of the ITS system 2 near the mobile terminal apparatuses 12a, 12b, 12c, 12d, the limited maximum transmitting power value is transmitted from the mobile communication system base station 11, so that the maximum transmitting power of each of the multiple frequency channels F1 to Fn is more largely limited as the frequency channel gets closer to the adjacent frequency band W2. For example, the mobile terminal apparatus 12a located in an area where the radio wave condition is good performs communication using the adjacent channel F1 whose maximum transmitting power is most largely limited. As the radio wave condition deteriorates, the frequency channel F2 to Fn having the maximum transmitting power with smaller limitation (having larger limited maximum transmitting power value) is selected, and the handover is performed.

In this way, the limited maximum transmitting power value is transmitted from the mobile communication system base station 11, so that the wireless resources are effectively used because it is possible that the maximum transmitting power of each of the multiple frequency channels F1 to Fn is not limited largely when the interference to the ITS system 2 is small, and the frequency channel Fn which is far away from the adjacent channel F1 is used without limiting the maximum transmitting power.

Here, the description of the fourth embodiment is completed, and the fifth embodiment will be described. Since a mobile terminal system 1_5 of the fifth embodiment has an approximately the same configuration as the first embodiment, the same reference letters are attached to the same elements as those of the first embodiment so that the description is omitted, and only the differences from the first embodiment will be described.

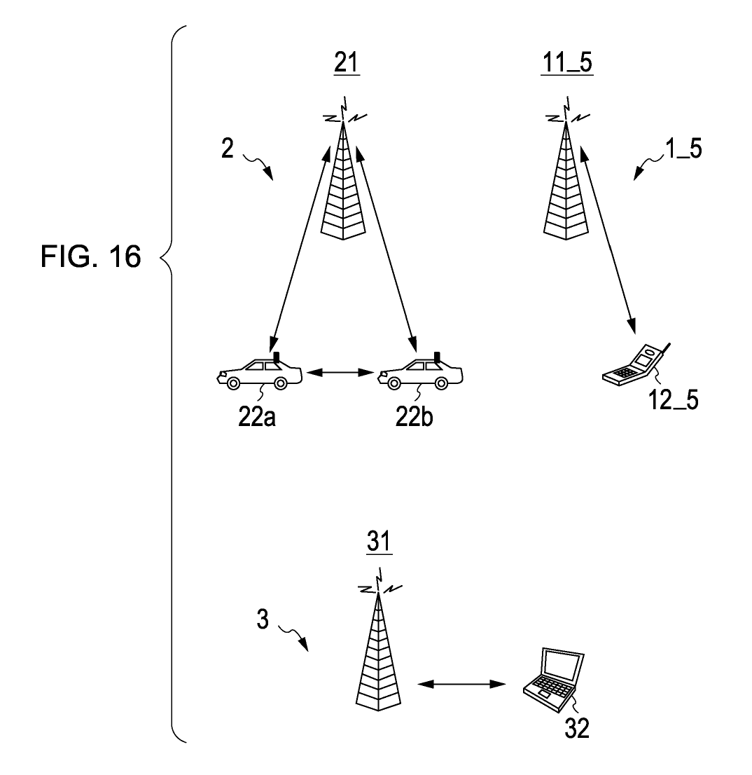

FIG. 16 is a schematic configuration diagram of the mobile terminal system 1_5 of the fifth embodiment and adjacent systems thereof.

In FIG. 16, in addition to the mobile terminal system 1_5 including a mobile terminal apparatus 12_5 and a mobile communication system base station 11_5, and the ITS system 2 including the vehicles 22a, 22b and the ITS base station 21, a wireless LAN system 3 in which wireless communication is performed between a personal computer 32 and a wireless LAN base station 31 is illustrated.

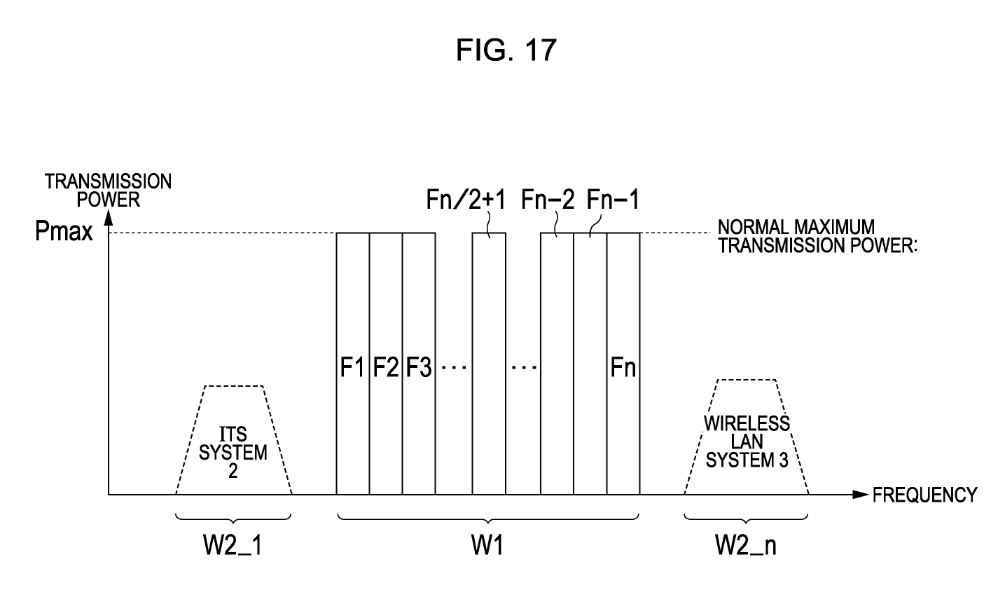

FIG. 17 is an illustration illustrating a relationship between frequency channels used in the mobile terminal system 1_5 and transmitting power of each frequency channel.

Also in this embodiment, the multiple frequency channels F1 to Fn belonging to the frequency band W1 are prepared for the mobile terminal system 1_5.

When there are not the ITS system 2 and the wireless LAN system 3 nearby, it is possible to use transmitting power up to the maximum transmitting power Pmax in each frequency channel F1 to Fn. In the ITS system 2, communication is performed by using a first adjacent frequency band W2_1 adjacent to the frequency channel F1, and in the wireless LAN system 3, communication is performed by using a second adjacent frequency band W2_n adjacent to the frequency channel Fn. Hereinafter, the frequency channel F1 is called a first adjacent channel F1 and the frequency channel Fn is called a second adjacent channel Fn.

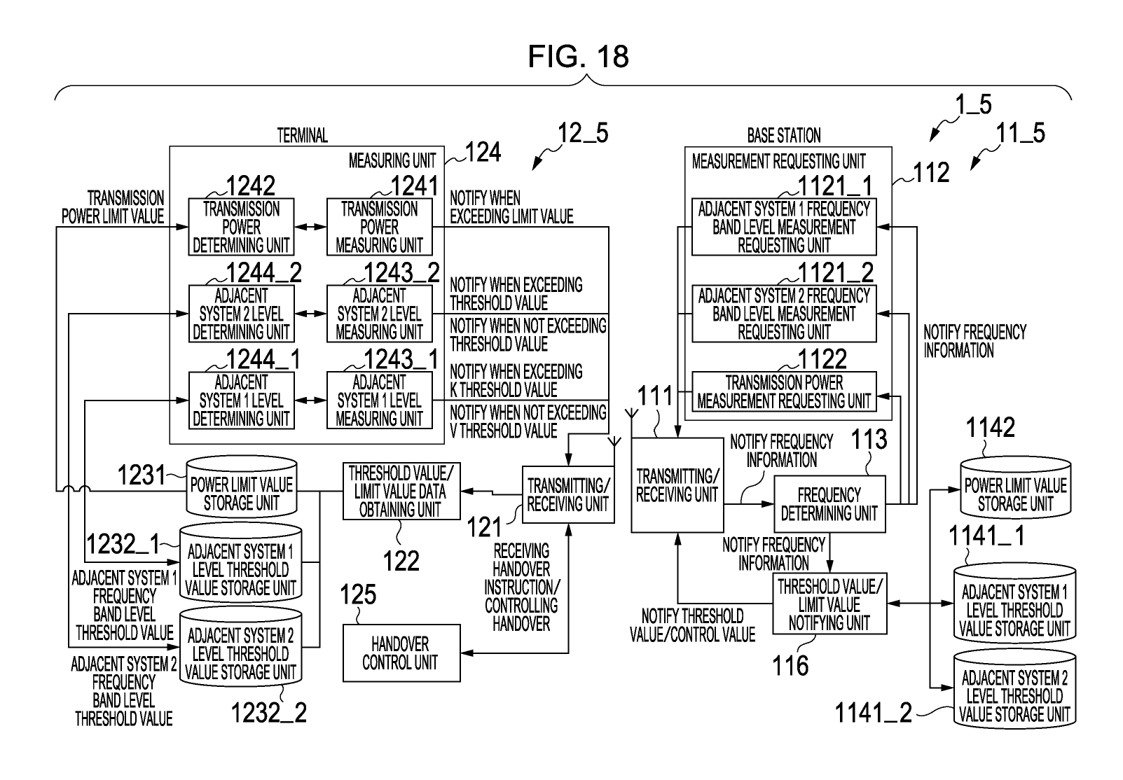

FIG. 18 is a block diagram of the mobile communication system base station 11_5 and the mobile terminal apparatus 12_5 constituting the mobile terminal system 1_5.

The mobile communication system base station 11_5 of this embodiment has an approximately the same configuration as the mobile communication system base station 11 of first embodiment illustrated in FIG. 2. Corresponding to each of the ITS system 2 and the wireless LAN system 3, an adjacent system 1 level measurement requesting unit 1121_1 for requesting a measurement of the radio wave level in the first adjacent frequency band W2_1 used by the ITS system 2 and an adjacent system 2 level measurement requesting unit 1121_2 for requesting a measurement of the radio wave level in the second adjacent frequency band W2_n used by the wireless LAN system 3 are included. And, an adjacent system 1 level threshold value storage unit 1141_1 for storing a threshold value (hereinafter called a first adjacent threshold value) of the radio wave level by which an apparatus of the ITS system 2 is determined to be nearby and an adjacent system 2 level threshold value storage unit 1141_2 for storing a threshold value (hereinafter called a second adjacent threshold value) of the radio wave level by which an apparatus of the wireless LAN system 3 is determined to be nearby are included.

The mobile terminal apparatus 12_5 also has an approximately the same configuration as the mobile terminal apparatus 12 of first embodiment illustrated in FIG. 2. Corresponding to each of the ITS system 2 and the wireless LAN system 3, an adjacent system 1 level threshold value storage unit 1232_1 for storing the first adjacent threshold value and an adjacent system 2 level threshold value storage unit 1232_2 for storing the second adjacent threshold value are included. And, an adjacent system 1 level measuring unit 1243_1 for measuring the radio wave level in the first adjacent frequency band W2_1, an adjacent system 2 level measuring unit 1243_2 for measuring the radio wave level in the second adjacent frequency band W2_n, an adjacent system 1 level determining unit 1244_1 for determining whether an electric power level in the first adjacent frequency band W2_1 exceeds the first adjacent threshold value or not, and an adjacent system 2 level determining unit 1244_2 for determining whether an electric power level in the second adjacent frequency band W2_n exceeds the second adjacent threshold value or not are included.

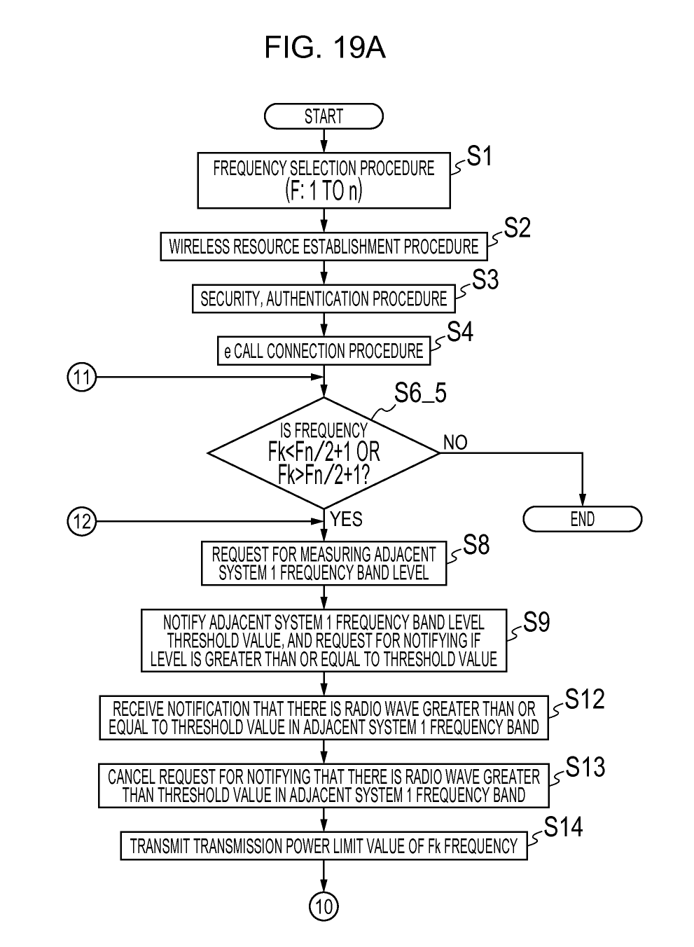

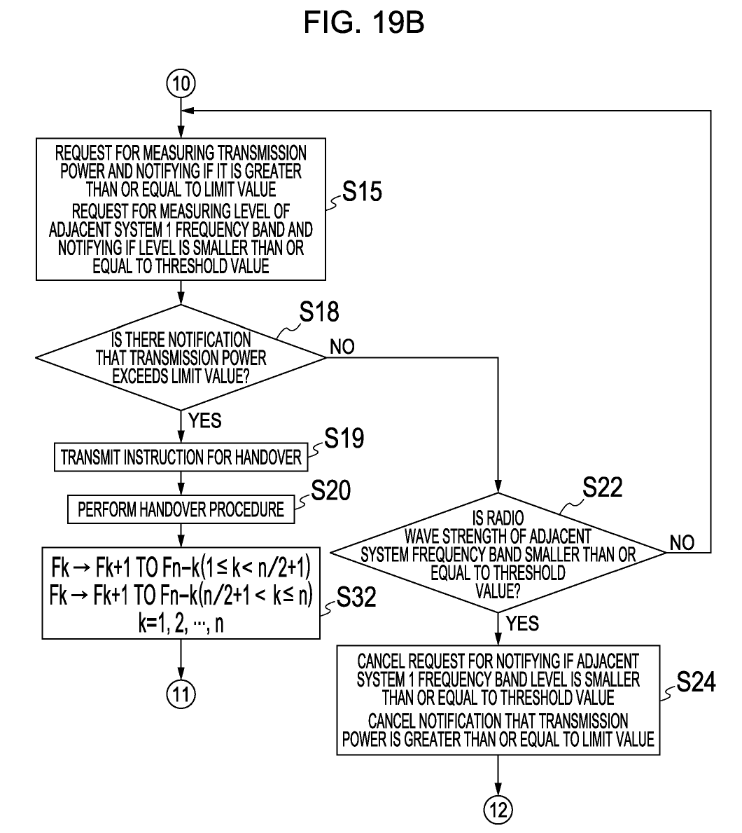

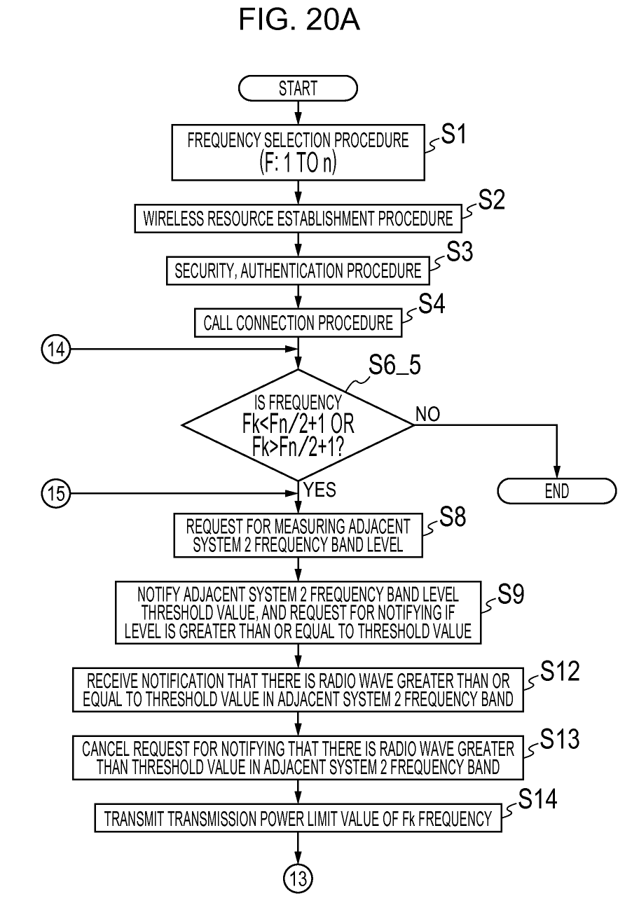

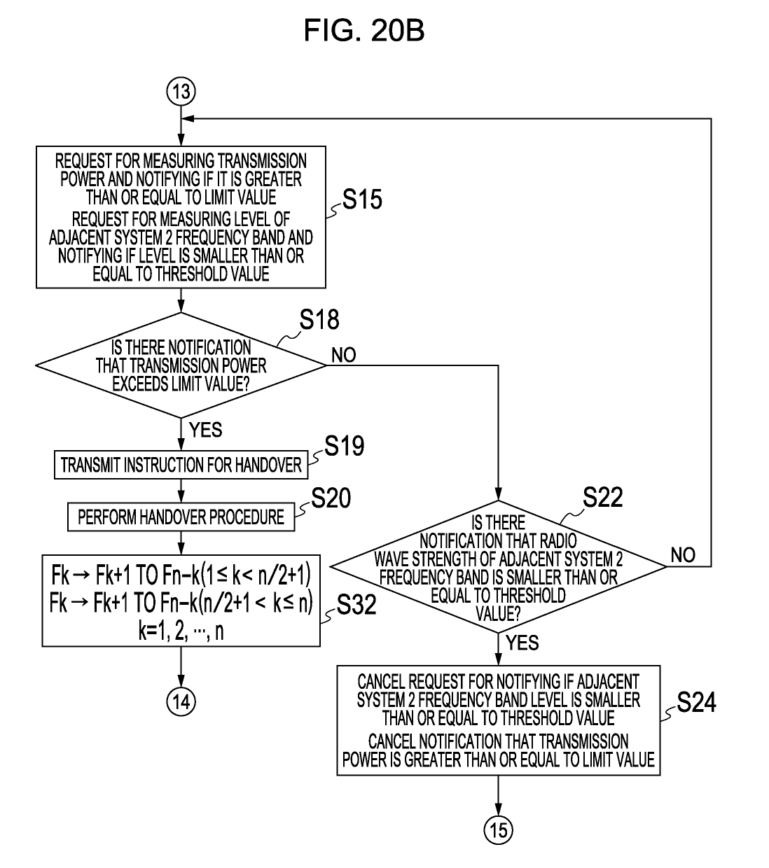

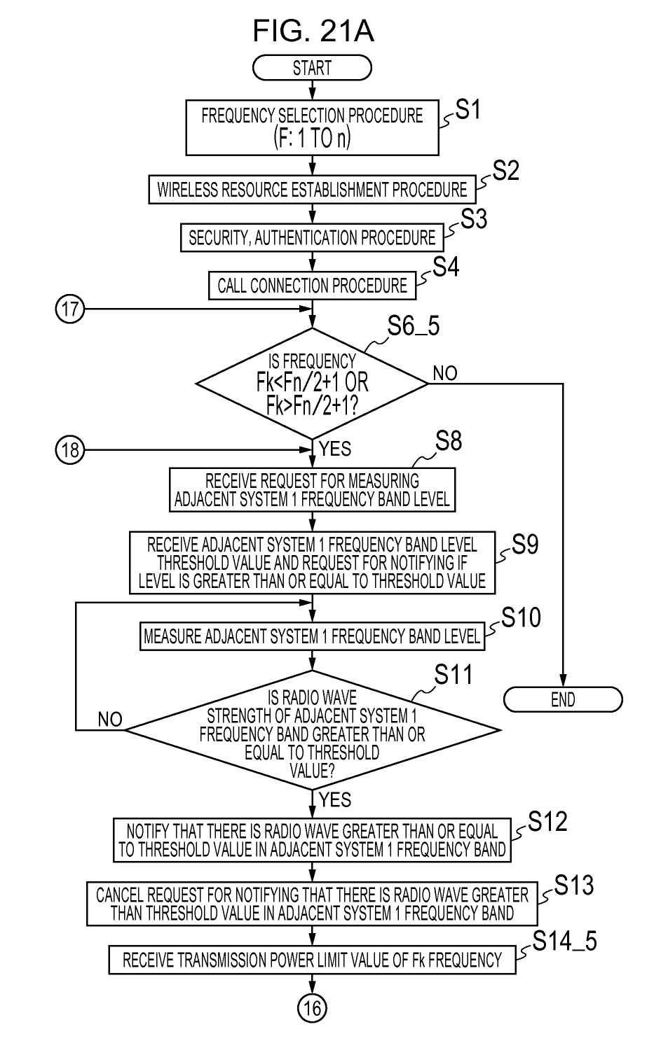

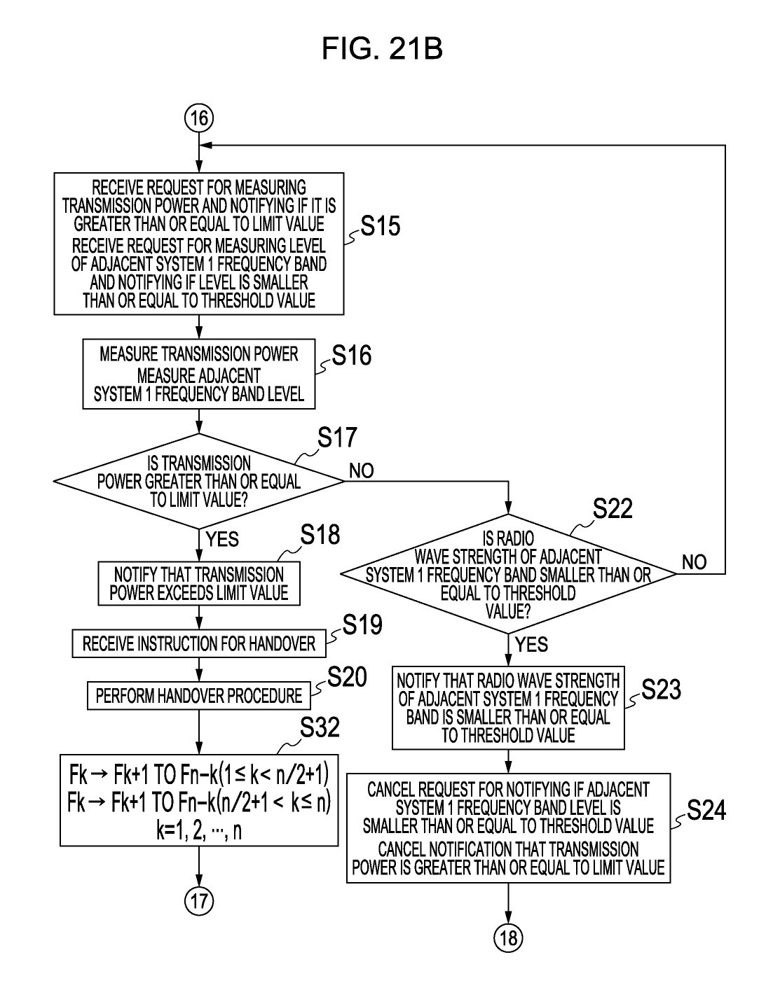

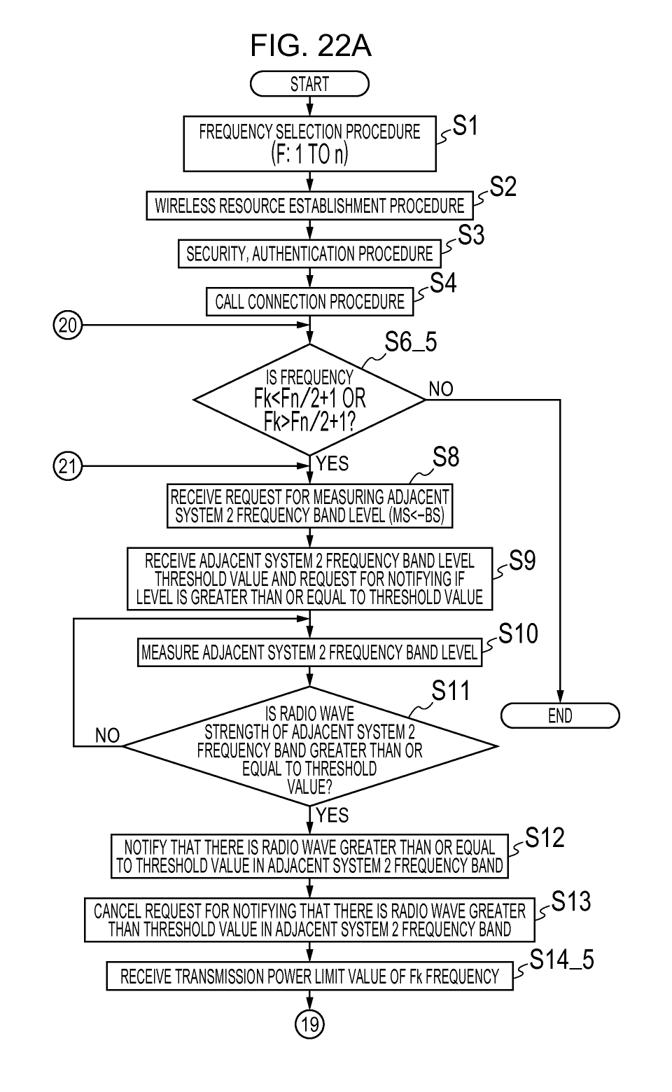

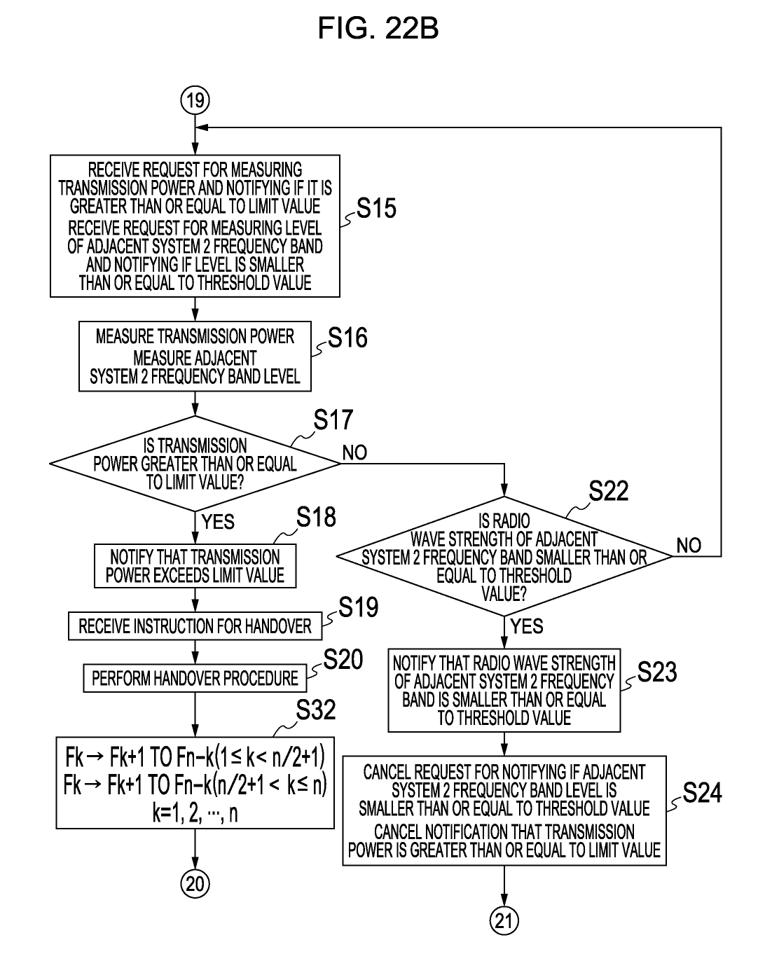

FIGS. 19A and 19B are illustrations illustrating a series of processing sequences of the mobile communication system base station 11_5 to the ITS system 2, and FIGS. 20A and 20B are illustrations illustrating a series of processing sequences of the mobile communication system base station 11_5 to the wireless LAN system 3. FIGS. 21A and 21B are illustrations illustrating a series of processing sequences of the mobile terminal apparatus 12_5 to the ITS system 2, and FIGS. 22A and 22B are illustrations illustrating a series of processing sequences of the mobile terminal apparatus 12_5 to the wireless LAN system 3.

In FIGS. 19A, 19B, 20A, 20B, 21A, 21B, 22A and 22B, the same reference number is attached to the same processing of FIGS. 5, 6A and 6B used in the first embodiment.

Also in this embodiment, in the same way as the first embodiment, first, the frequency channel F1 to Fn is selected according to the radio wave condition (step S1 in FIGS. 19A, 20A, 21A, 22A), and a wireless resource is established (step S2 in FIGS. 19A, 20A, 21A, 22A). And, authentication of the mobile terminal 12_5 (step S3 in FIGS. 19A, 20A, 21A, 22A), and a call connection procedure (step S4 in FIGS. 19A, 20A, 21A, 22A) are performed.

When the selected frequency channel Fx is a frequency channel other than the frequency channel F(n/2+1) at the center of the frequency band W1 illustrated in FIG. 17, a request for measuring the radio wave level in the first adjacent frequency band W2_1 (step S8 in FIG. 19A) and a request for measuring the radio wave level in the second adjacent frequency band W2_n (step S8 in FIG. 20A) are transmitted from the mobile communication system base station 11_5 to the mobile terminal apparatus 12_5. A request for notifying if the radio wave level in the first adjacent frequency band W2_1 is greater than or equal to the first adjacent threshold value (step S9 in FIG. 19A) and a request for notifying if the radio wave level in the second adjacent frequency band W2_n is greater than or equal to the second adjacent threshold value (step S9 in FIG. 20A) are transmitted.

In the mobile terminal apparatus 12_5, the radio wave level in the first adjacent frequency band W2_1 of the ITS system 2 is measured by the adjacent system 1 level measuring unit 1243_1 (step S10 in FIG. 21A). When the radio wave level in the first adjacent frequency band W2_1 is determined to be greater than or equal to the first adjacent threshold value (step S11 in FIGS. 21A: Yes), a reply notification concerning the radio wave level in the first adjacent frequency band W2_1 is transmitted to the mobile communication system base station 11_5 (step S12 in FIGS. 19A, 21A). Furthermore, the radio wave level in the second adjacent frequency band W2_n in the LAN system 3 is measured by the adjacent system 2 level measuring unit 1243_2 (step S10 in FIG. 22A). When the radio wave level in the second adjacent frequency band W2_n is determined to be greater than or equal to the second adjacent threshold value (step S11 in FIGS. 22A: Yes), a reply notification concerning the radio wave level in the second adjacent frequency band W2_n is transmitted to the mobile communication system base station 11_5 (step S12 in FIGS. 20A, 22A).

The mobile communication system base station 11 cancels the reply notification request concerning each of the ITS system 2 and the wireless LAN system 3 (step S13 in FIGS. 19A, 20A). The limited maximum transmitting power value corresponding to the selected frequency channel Fx is transmitted to the mobile terminal apparatus 12_5 (step S14 in FIGS. 19A, 20A). In addition, the transmitting power measurement request, the reply notification request of the transmitting power, the adjacent system level measurement request of the first adjacent frequency band W2_1, the adjacent system level measurement request of the second adjacent frequency band W2_n, and the reply notification requests of the adjacent radio wave levels are transmitted (step S15 in FIGS. 19B, 20B).

In the mobile terminal apparatus 12_5, the transmitting power, the radio wave level in the first adjacent frequency band W2_1, and the radio wave level in the second adjacent frequency band W2_n are measured (step S16 in FIGS. 21B, 22B).

When the transmitting power is smaller than the limited maximum transmitting power value (step S17 in FIGS. 21B, 22B: No), if the radio wave level of the first adjacent frequency band W2_1 or the second adjacent frequency band W2_n is greater than corresponding adjacent threshold value (step S22 in FIGS. 19B, 20B, 21B, 22B: No), the measurements of the radio wave level and the transmitting power are repeated. When the radio wave level of the first adjacent frequency band W2_1 or the second adjacent frequency band W2_n reaches the level smaller than or equal to corresponding adjacent threshold value (step S22 in FIGS. 19B, 20B, 21B, 22B: Yes), the reply notification is transmitted from the mobile terminal apparatus 12_5 to the mobile communication system base station 11_5 (step S23 in FIGS. 21B, 22B). And, various reply notification requests are cancelled (step S24 in FIGS. 19B, 20B, 21B, 22B).

When the measured transmitting power exceeds the limited maximum transmitting power value (step S17 in FIGS. 21B, 22B: Yes), the reply notification of the transmitting power is transmitted from the mobile terminal apparatus 12_5 to the mobile communication system base station 11 (step S18 in FIGS. 21B, 22B), and in accordance with the handover instruction (step S19 in FIGS. 19B, 20B), the handover procedure is performed (step S20 in FIGS. 19B, 20B, 21B, 22B).

When the handover is completed (step S32 in FIGS. 19B, 20B, 21B, 22B), the above processings are repeated on the newly selected frequency channel.

In this way, in the mobile terminal system 1_5 of this embodiment, the radio wave levels of the adjacent frequency bands W2_1 and W2_n in the ITS system 2 and the wireless LAN system 3 are observed respectively, and the limited maximum power value of each of the frequency channels F1 to Fn and a post-handover frequency channel are determined in accordance with the observation result.

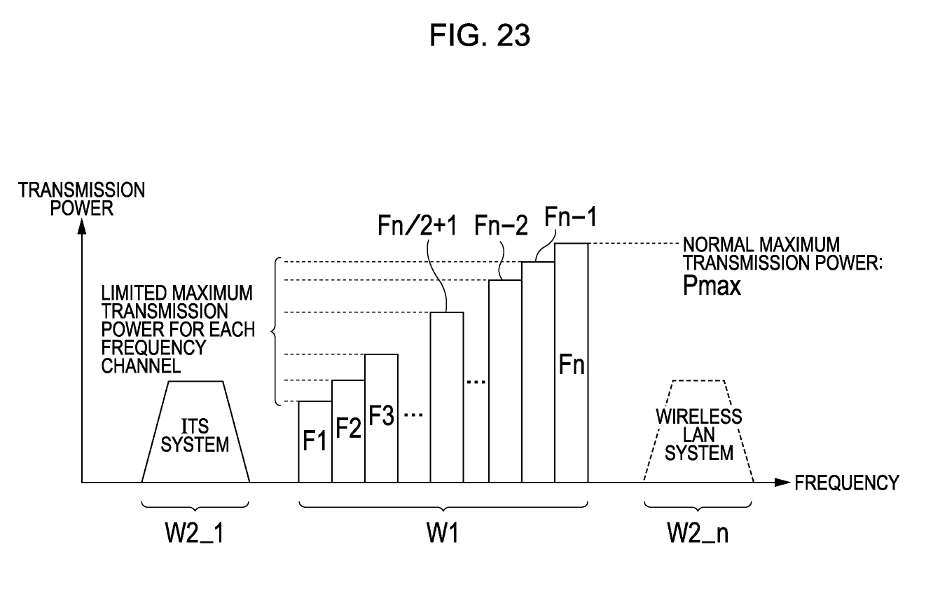

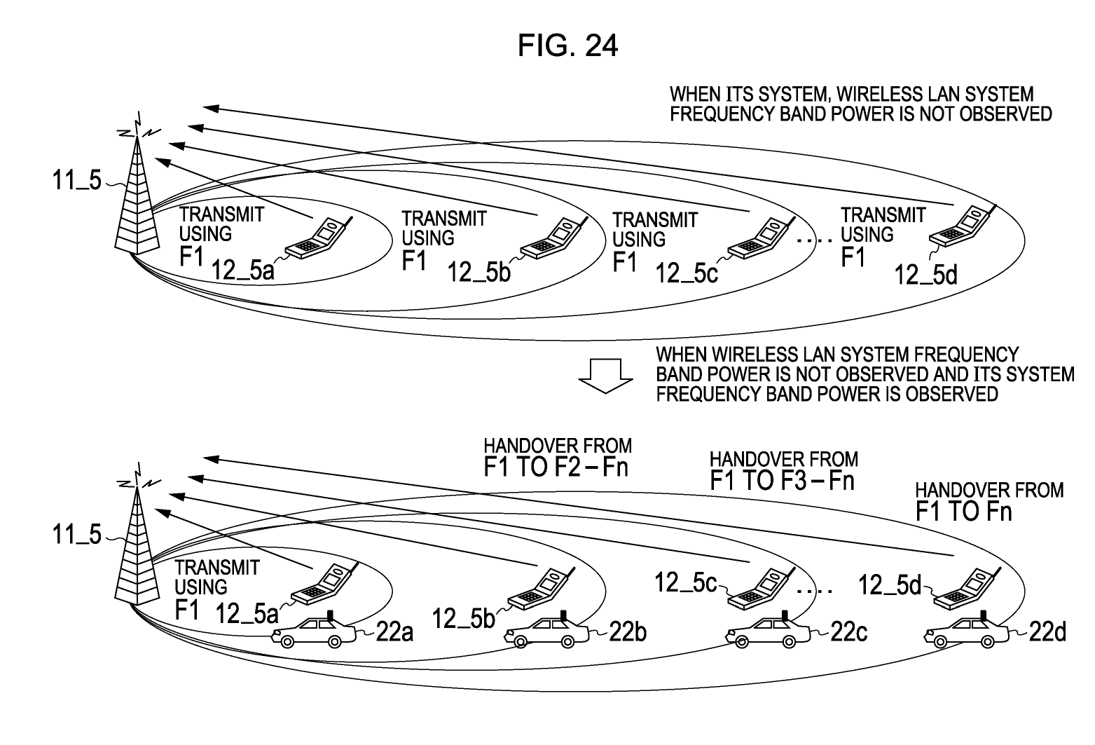

FIG. 23 is an illustration illustrating the maximum transmitting power of each of the frequency channels F1 to Fn when only the ITS system 2 is observed, and FIG. 24 is an illustration illustrating the frequency channels used by the mobile terminal apparatuses 12_5 when only the ITS system 2 is observed.

When the radio wave level of the second adjacent frequency band W2_n allocated to the wireless LAN system 3 is smaller than the second adjacent threshold value and the radio wave level of the first adjacent frequency band W2_1 allocated to the ITS system 2 is greater than or equal to the first adjacent threshold value, only the ITS system 2 is considered to be near the mobile terminal apparatus 12_5. At this time, the frequency channel F1 near to the first adjacent frequency band W2_1 of the ITS system 2 becomes the adjacent channel F1, and the maximum transmitting power is more largely limited as the frequency channel gets closer to the adjacent channel F1. Therefore, as illustrated in FIG. 23, the transmitting power available to each frequency channel decreases as the frequency channel gets closer to the first adjacent frequency band W2_1 of the ITS system 2, and increases as the frequency channel gets closer to the second adjacent frequency band W2_n of the wireless LAN system 3.

As illustrated in FIG. 24, when there are not the ITS system 2 and the wireless LAN system 3 near the mobile terminal apparatuses 12_5a, 12_5b, 12_5c, 12_5d, each of the mobile terminal apparatuses 12_5a, 12_5b, 12_5c, 12_5d selects a frequency channel having the best radio wave condition from the multiple frequency channels F1 to Fn and performs communication. When there are the vehicles 22a, 22b, 22c, 22d of the ITS system 2 near the mobile terminal apparatuses 12_5a, 12_5b, 12_5c, 12_5d, the maximum transmitting power of each of the multiple frequency channels F1 to Fn is more largely limited as the frequency channel gets closer to the first adjacent frequency band W2_1. For example, the mobile terminal apparatus 12_5a located in an area where the radio wave condition is good performs communication by using the adjacent channel F1 which is nearest to the first adjacent frequency band W2_1 and whose maximum transmitting power is most largely limited, and as the radio wave condition gets worse, a frequency channel F2 to Fn that is farther from the first adjacent frequency band W2_1 and has larger limited maximum transmitting power is selected to perform the handover.

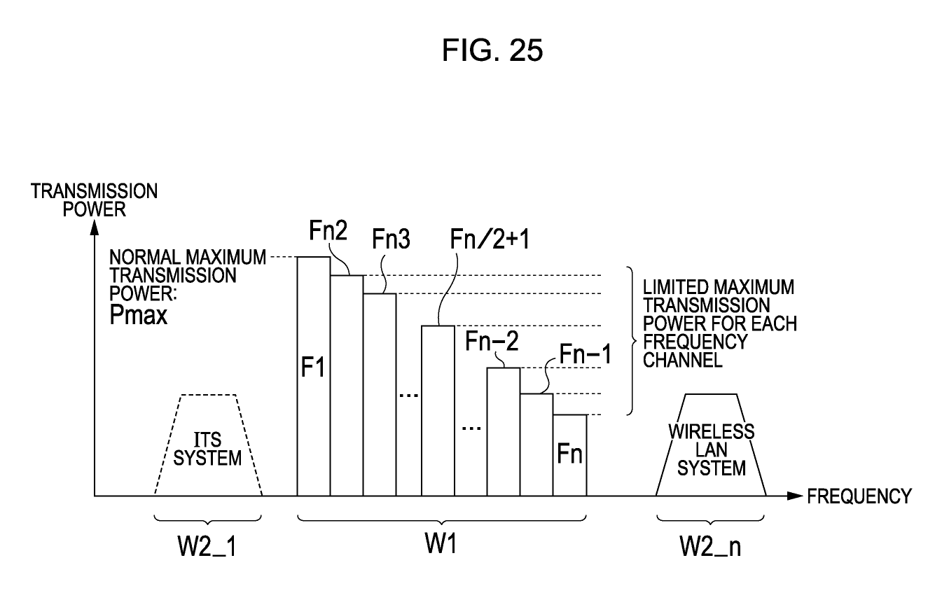

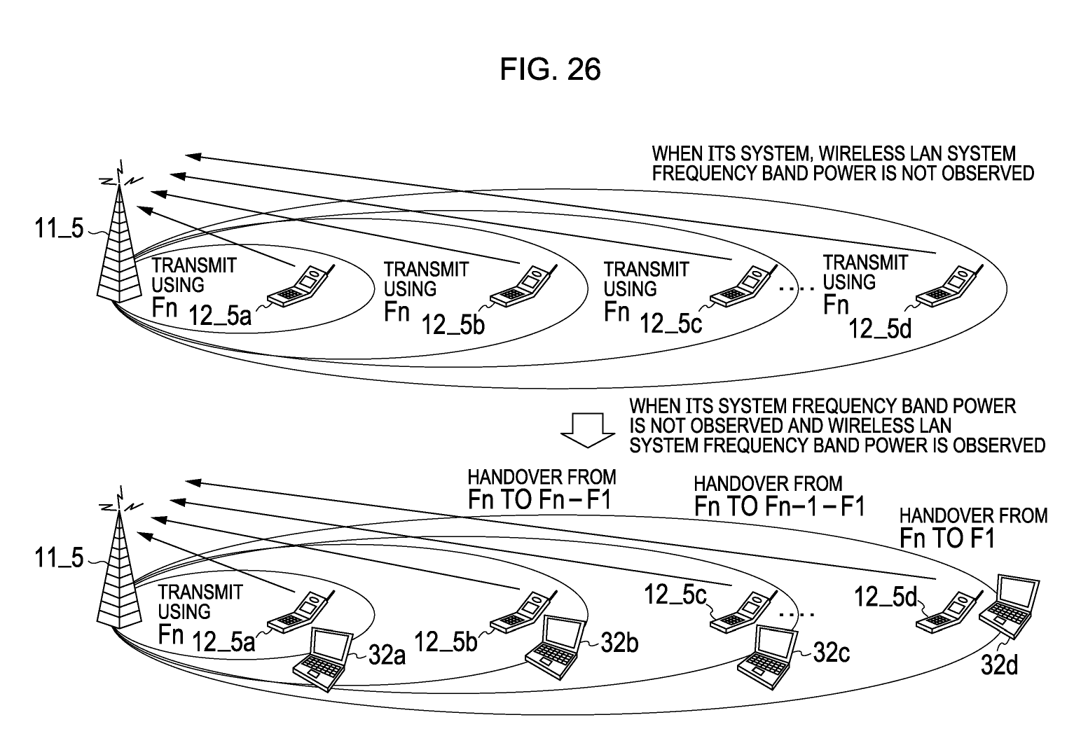

FIG. 25 is an illustration illustrating the maximum transmitting power of each of the frequency channels F1 to Fn when only the wireless LAN system 3 is observed, and FIG. 26 is an illustration illustrating the frequency channels used by the mobile terminal apparatuses 12_5 when only the wireless LAN system 3 is observed.

When the radio wave level of the second adjacent frequency band W2_n allocated to the wireless LAN system 3 is greater than or equal to the second adjacent threshold value and the radio wave level of the first adjacent frequency band W2_1 allocated to the ITS system 2 is smaller than the first adjacent threshold value, only the wireless LAN system 3 is considered to be near the mobile terminal apparatus 12_5. At this time, the frequency channel Fn near to the second adjacent frequency band W2_n of the wireless LAN system 3 becomes the adjacent channel. The transmitting power available to each frequency channel, being opposite to the case illustrated in FIG. 23, increases as the frequency channel gets closer to the first adjacent frequency band W2_1 of the ITS system 2, and decreases as the frequency channel gets closer to the second adjacent frequency band W2_n of the wireless LAN system 3.

As illustrated in FIG. 26, when there are personal computers 32a, 32b, 32c, 32d of the wireless LAN system 3 near the mobile terminal apparatuses 12_5a, 12_5b, 12_5c, 12_5d, the maximum transmitting power of each of the multiple frequency channels F1 to Fn is more largely limited as the frequency channel gets closer to the second adjacent frequency band W2_n. For example, the mobile terminal apparatus 12_5a located in an area where the radio wave condition is good performs communication by using the adjacent channel Fn which is nearest to the second adjacent frequency band W2_n, and as the radio wave condition gets worse, being opposite to the case illustrated in FIG. 24, the frequency channel

F1 that is far away from the adjacent channel Fn and near to the first adjacent frequency band W2_1 of the ITS system 2 is selected.

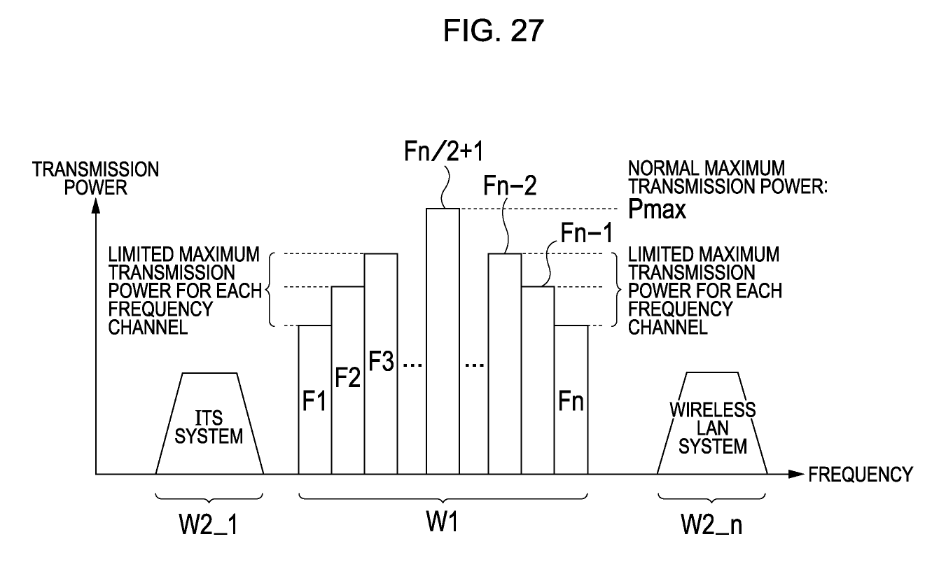

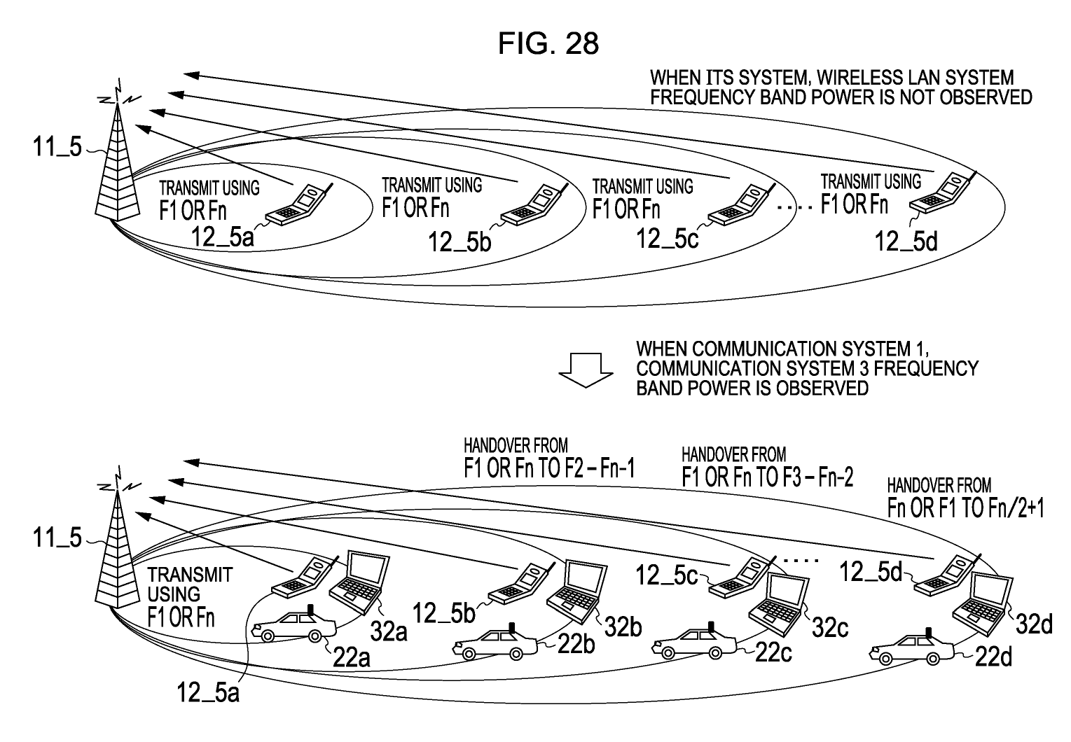

FIG. 27 is an illustration illustrating the maximum transmitting power of each of the frequency channels F1 to Fn when both of the ITS system 2 and the wireless LAN system 3 are observed, and FIG. 28 is an illustration illustrating the frequency channels used by the mobile terminal apparatuses 12_5 when both of the ITS system 2 and the wireless LAN system 3 are observed.

When both of the ITS system 2 and the wireless LAN system 3 are observed, both of the frequency channel F1 near the first adjacent frequency band W2_1 of the ITS system 2 and the frequency channel Fn near the second adjacent frequency band W2_n of the wireless LAN system 3 become the adjacent channels, and the maximum transmitting power is more largely limited as the frequency channel gets closer to the adjacent channels F1, Fn. Therefore, as illustrated in FIG. 27, the transmitting power available to each frequency channel decreases as the frequency channel gets closer to each of the adjacent channels F1, Fn at both ends, and increases as the frequency channel gets closer to the frequency channel F(n/2+1) in the center.

As illustrated in FIG. 28, when there are both the ITS system 2 and the wireless LAN system 3 near the mobile terminal apparatuses 12_5a, 12_5b, 12_5c, 12_5d, for example, the mobile terminal apparatus 12_5a located in an area where the radio wave condition is good performs communication using either of the adjacent channels F1, Fn. In the mobile terminal apparatuses 12_5b, the frequency channel F2 or F(n−1) whose maximum transmitting power is second most largely limited is selected. In the mobile terminal apparatuses 12_5c, the frequency channel F3 or F(n−2) whose maximum transmitting power is third most largely limited is selected, and in the mobile terminal apparatuses 12_5d, the frequency channel F(n/2+1) whose maximum transmitting power is not limited is selected.

As described above, according to the mobile terminal system 1_5 of this embodiment, the interference to both other systems can be reduced.

Although, in the above description, a mobile phone is illustrated as an example of the mobile station apparatus, the mobile station apparatus may also be a PDA (Personal Digital Assistant), a portable type game machine, and the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A wireless communication system capable of using a plurality of frequency channels in a first predetermined frequency band being adjacent a second predetermined frequency band used in another wireless communication system, the wireless communication system comprising:
a base station; and
a mobile station for communicating with wireless communication to the base station;
wherein the base station includes a power limit controller for sending a notification for limiting each power of the plurality of frequency channels at the mobile station; and
wherein the mobile station includes:
a transmitter capable of transmitting data to the base station by the use of at least one of the frequency channel in the plurality of frequency channels in the first predetermined frequency band, and
a channel controller for decreasing a transmitting power of the frequency channel used in transmitting the data than the transmitting powers of the other frequency channels when the frequency channel for transmitting the data is an adjacent frequency channel of the second predetermined frequency band on the bases of the notification of the power limit controller of the base station, and requesting to change the frequency channel used in transmitting the data to the base station when the frequency channel used in transmitting the data is an adjacent frequency channel of the second predetermined frequency band and the mobile station demands more transmitting power for transmitting the data.

2. The wireless communication system of the claim 1, wherein the power limit controller sets limit of powers in the notification so as to decrease the transmitting power of the frequency channels as the frequency channels approach the second predetermined frequency band.

3. The wireless communication system of the claim 1, wherein the power limit controller sets a predetermined power in the notification at the frequency channel adjacent to the second predetermined frequency band.

4. The wireless communication system of the claim 1, wherein the mobile station includes a level detector for detecting a power of the second predetermined frequency band; and wherein the power limit controller sets a power of the frequency channel in the notification in accordance with a result of the level detector.

5. The wireless communication system of the claim 1, wherein the channel controller compares traffic of the frequency channels and requests the frequency channel using in transmitting the data to the transmitter to change the frequency channel using in transmitting the data into the most smallest traffic frequency channel in the frequency channels.

6. The wireless communication system of the claim 1, wherein the channel controller searches open frequency channels in the frequency channels and requests the frequency channel using in transmitting the data to the transmitter to change the frequency channel using in transmitting the data into the most earliest traffic frequency channel in the open frequency channels.

7. A mobile station for communicating to a base station with a wireless communication capable of using a plurality of frequency channels in a first predetermined frequency band being adjacent a second predetermined frequency band used in another wireless communication system, mobile station comprising:
a transmitter capable of transmitting data to the base station by the use of at least one of the frequency channel in the plurality of frequency channels in the first predetermined frequency band, and
a channel controller for decreasing a transmitting power of the frequency channel used in transmitting the data than the transmitting powers of the other frequency channels when the frequency channel for transmitting the data is an adjacent frequency channel of the second predetermined frequency band on the bases of the notification of the power limit controller of the base station, and requesting to change the frequency channel used in transmitting the data to the base station when the frequency channel used in transmitting the data is an adjacent frequency channel of the second predetermined frequency band and the mobile station demands more transmitting power for transmitting the data.

8. The mobile station of the claim 7, further comprising a transmitting power measure for measuring power of the second predetermined frequency band.

9. The mobile station of the claim 7, wherein the channel controller compares traffic of the frequency channels and requests the frequency channel using in transmitting the data to the transmitter to change the frequency channel using in transmitting the data into the most smallest traffic frequency channel in the frequency channels.

10. The mobile station of the claim 8, wherein the channel controller searches open frequency channels in the frequency channels and requests the frequency channel using in transmitting the data to the transmitter to change the frequency channel using in transmitting the data into the most earliest traffic frequency channel in the open frequency channels.

11. A base station for communicating to a mobile station with a wireless communication capable of using a plurality of frequency channels in a first predetermined frequency band being adjacent a second predetermined frequency band used in another wireless communication system, the base station comprising:
a power limit controller for sending a notification for limiting received powers of the plurality of frequency channels in the base station; and
a transceiver for sending a signal including data and the notification to the mobile station and for receiving signal from the mobile station.
